(19) United States
(12) Patent Application Publication
(10) Pub. No.: US 2026/0154857 A1
(43) Pub. Date: Jun. 4, 2026

(54) Style-Aligned Object Image Generation

(71) Applicant: Google LLC, Mountain View, CA (US)

(72) Inventors: Amit Handa, Milpitas, CA (US); Andrey Voynov, Tel Aviv (IL); Zhongyue Zheng, Millbrae, CA (US); Clarisse Neu, San Francisco, CA (US); Aravind Balakrishnan, Saratoga, CA (US); Amir Hertz, Tel Aviv (IL); Apurv Suman, New York City, NY (US); Ashish Dilipchand Bora, Sunnyvale, CA (US); Xibing Yang, Fremont, CA (US); Shubham Swapnil, Santa Clara, CA (US); Elchonon Zev Lapin, Scottsdale, CA (US); Risa Park, Ithaca, NY (US); Alan Yui-Hin Chin, San Carlos, CA (US)

(21) Appl. No.: 19/391,555

(22) Filed: Nov. 17, 2025

Related U.S. Application Data
(60) Provisional application No. 63/727,814, filed on Dec. 4, 2024.

(51) Int. Cl. G06T 11/00; G06N 20/00

(52) U.S. Cl. CPC G06T 11/00; G06N 20/00

(57) ABSTRACT

Systems and methods for style-aligned image generation can obtain and process an object image, a style image, and a text description to generate a model-generated style-aligned object image. The systems and methods can generate the model-generated style-aligned object image with an image generation model that performs mask embedding processing for the object image and performs reduced attention sharing during the diffusion process for style-aligning the images without style image generalization.

### PRIORITY CLAIM

The present application is based on and claims priority to U.S. Provisional Application No. 63/727,814 having a filing date of Dec. 4, 2024. Application claims priority to and the benefit of each of such application and incorporates all such application herein by reference in its entirety.

### FIELD

The present disclosure relates generally to style-aligned image generation. More particularly, the present disclosure relates to processing an object image, a style image, and a text description with an image generation model to generate a model-generated style-aligned object image.

### BACKGROUND

Generative model image generation can cause some objects and/or details to be rendered irregularly. For example, the size proportions may be rendered inaccurately, and/or artifacts and/or other abnormalities may be rendered. For instances in which a user desires an object to be rendered accurately as a showcase for the object, traditional generative models alone may not provide a desired outcome.

In addition, the content being requested by the user may not be readily available to the user based on the user not knowing where to search, based on the storage location of the content, and/or based on the content not existing. The user may be requesting search results based on an imagined concept without a clear way to express the imagined concept.

Additionally, viewing an object in different scenes and/or with other objects can inspire a user. The user may be inspired to obtain and/or use an object for a particular task based on how an object is displayed in an image and/or with what an object is displayed within an image. For example, product placement can be utilized to market different products and can provide users with an imagined use and/or location of use for the given product. Marketing campaigns can be expensive and time consuming, which may lead to limited diversity in the images of particular products.

### SUMMARY

Aspects and advantages of embodiments of the present disclosure will be set forth in part in the following description, or can be learned from the description, or can be learned through practice of the embodiments.

One example aspect of the present disclosure is directed to a computing system for style-aligned image generation. The system can include one or more processors and one or more non-transitory computer-readable media that collectively store instructions that, when executed by the one or more processors, cause the computing system to perform operations. The operations can include obtaining an object image, a style image, and a text description. The object image can depict a particular object. The style image can include a particular style. The text description can include a request for a scene comprising one or more particular features. The operations can include processing the object image, the style image, and the text description with an image generation model to generate a model-generated image. The model-generated image can depict the particular object within a model-generated scene that includes the one or more particular features. The model-generated image can include the particular style. The image generation model can generate the model-generated image by: generating an object mask based on the object image, generating an object embedding based on the object image and the object mask, wherein the object embedding is descriptive of a plurality of object features, generating a model-generated scene based on the style image and the text description, and generating the model-generated image based on the model-generated scene and the object embedding. The object mask can be descriptive of a silhouette of the particular object depicted in the object image. The model-generated scene can include pixel data descriptive of the one or more particular features requested by the text description. The model-generated scene can include the particular style of the style image. In some implementations, the model-generated image can include the particular object rendered into the model-generated scene. The operations can include providing the model-generated image as output.

In some implementations, the object mask and object embedding can be generated with the image generation model. Generating a model-generated scene based on the style image and the text description can include performing an attention sharing bypass during the diffusion process. The particular style of the style image can include at least one of a specific image saturation, a specific contrast, a specific lighting, a specific filter, or a specific visual effect.

In some implementations, obtaining the style image can include obtaining metadata associated with a user, determining a web resource associated with the metadata, and determining a particular content item from the web resource to obtain as the style image. The image generation model can perform adaptive instance normalization during model-generated scene generation. The object embedding can include a learned probability distribution associated with a plurality of color values and a plurality of opacity values.

In some implementations, the model-generated scene can be generated without fine-tuning the image generation model on a plurality of training images that comprise the particular style of the style image. The image generation model can include a transformer model. The model-generated scene can be generated based on allowing target features of the style image to bypass at least a portion of a self-attention block of the transformer model. The image generation model can include a diffusion model trained to generate novel images based on processing a text string.

Another example aspect of the present disclosure is directed to a computer-implemented method for style-aligned image generation. The method can include obtaining, by a computing system including one or more processors, an object image, a style image, and a text description. The object image can depict a particular object. The style image can include a particular style. The text description can include a request for a background comprising one or more particular features. The method can include processing, by the computing system, the object image to generate an object mask descriptive of a silhouette of the particular object depicted in the object image and processing, by the computing system, the object image and the object mask to generate an object embedding. The object embedding can be descriptive of a plurality of object features. The method can include processing, by the computing system, the style image and the text description with an image generation model to generate a model-generated background that includes pixel data descriptive of the one or more particular features requested by the text description and comprising the particular style of the style image. The method can include processing, by the computing system, the model-generated background and the object embedding with the image generation model to generate a model-generated image that includes the particular object rendered into the model-generated background. The method can include providing, by the computing system, the model-generated image as output.

In some implementations, the text description can be based on an input search query input by a user. The object image can be at least one of: determined based on performing a search with at least a portion of the input search query or input with the input search query by the user. The style image can be determined based on a context associated with the input search query being input.

In some implementations, obtaining the style image can include obtaining a plurality of example images associated with a user, generating an image cluster based on determining at least a subset of the plurality of example images include a shared style and generating the style image based on the image cluster. The particular style of the style image can include a specific composition of target features of the style image. Target features can be assorted in a particular configuration.

Another example aspect of the present disclosure is directed to one or more non-transitory computer-readable media that collectively store instructions that, when executed by one or more computing devices, cause the one or more computing devices to perform operations. The operations can include obtaining an object image, a style image, and a text description. The object image can depict a particular object. The style image can include a particular style. The text description can include a request for a scene comprising one or more particular features. The operations can include processing the object image with an image generation model to generate an object embedding. The object embedding can be generated by: generating an object mask descriptive of a silhouette of the particular object depicted in the object image and generating the object embedding based on the object image and the object mask. The object embedding can be descriptive of a plurality of object features. The operations can include processing the style image and the text description with the image generation model to generate a model-generated scene that comprises pixel data descriptive of the one or more particular features requested by the text description and including the particular style of the style image and processing the model-generated scene and the object embedding with the image generation model to generate a model-generated image that includes the particular object rendered into the model-generated scene. The operations can include providing the model-generated image for display.

In some implementations, the model-generated scene can be generated without fine-tuning the image generation model on the particular style of the style image. The model-generated scene can differ from a first scene depicted in the object image. The model-generated scene can differ from a second scene depicted in the style image. The particular object can differ from the plurality of objects depicted in the style image. In some implementations, the image generation model can include a generative text-to-image model that was pre-trained to generate a plurality of pixel predictions based on an input text string.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example style-aligned image generation system according to example embodiments of the present disclosure.

FIG. 2 depicts a block diagram of an example image generation model system according to example embodiments of the present disclosure.

FIG. 3 depicts a flow chart diagram of an example method to perform style-aligned image generation according to example embodiments of the present disclosure.

FIG. 4 depicts illustrations of an example generation studio interface according to example embodiments of the present disclosure.

FIG. 5A depicts a block diagram of an example processing pipeline according to example embodiments of the present disclosure.

FIG. 5B depicts illustrations of example style-aligned images according to example embodiments of the present disclosure.

FIG. 6A depicts a block diagram of an example self-attention inference system according to example embodiments of the present disclosure.

FIG. 6B depicts block diagrams of example vanilla self-attention schemes according to example embodiments of the present disclosure.

FIG. 6C depicts a block diagram of an example shared self-attention system according to example embodiments of the present disclosure.

FIG. 6D depicts a diagram of an example shared self-attention system with target-reference attending according to example embodiments of the present disclosure.

FIG. 7 depicts a flow chart diagram of an example method to perform style-aligned diffusion processing according to example embodiments of the present disclosure.

FIG. 8 depicts a flow chart diagram of an example method to perform object-accurate image generation according to example embodiments of the present disclosure.

FIG. 9 depicts illustrations of example inputs and outputs according to example embodiments of the present disclosure.

FIG. 10A depicts a block diagram of an example computing system that performs style-aligned object image generation according to example embodiments of the present disclosure.

FIG. 10B depicts a block diagram of an example computing system that performs style-aligned object image generation according to example embodiments of the present disclosure.

Reference numerals that are repeated across plural figures are intended to identify the same features in various implementations.

### DETAILED DESCRIPTION

Generally, the present disclosure is directed to systems and methods for style-aligned image generation. In particular, the systems and methods disclosed herein can leverage a partial attention sharing bypass and mask embedding generation to generate a model-generated style-aligned object image. For example, the style-aligned image generation system can obtain an object image, a style image, and a text description to generate a model-generated style-aligned object image that includes a scene described with the text description with the style of the style image and the object of the object image. The object image can depict the particular object in one or more first scenes that differ from the model-generated scene (e.g., a bottle of cologne on a conveyor belt). The style image can depict a style and may include objects irrelevant to the text description, which may not be included in the model-generated style-aligned object image (e.g., an image that depicts a room with flowers that are placed at the bottom left with a high exposure filter and blue saturation). The text description can include a description of a requested scene (e.g., “a desert with a cactus”). The style-aligned image generation system can process the inputs to generate the model-generated style-aligned object image such that the particular object of the object image maintains geometric and identifiable features while rendering a scene that meets the criteria of the text description, while having the style of the style image regardless of the objects depicted in the style image (e.g., the model-generated image may depict the bottle of cologne in a desert next to a cactus, which may be in the bottom left corner, and the model-generated image may have a high exposure filter and blue saturation).

The systems and methods can perform the style-aligned generation by processing the product image to generate an object mask then generate an object embedding based on the object mask, processing the style image and the text description to generate a model-generated scene that is generated based on reduced attention sharing during the diffusion process, and rendering the object within the model-generated scene based on the object embedding. The systems and methods can include an image generation model configured, tuned, and/or trained to perform mask embedding and diffusion based image generation with minimal attention sharing during the diffusion process to perform style alignment.

Style-aligned image generation can be utilized to render objects in different environments. The different environments can be rendered based on a text description and an image that provides a style example. For example, a user can input an object image (e.g., a product image), a style image, and a text string. The style-aligned image generation system can generate a new image that includes the object from the object image (e.g., a product from a product image) in a scene described by the text string with the style of the style image.

Existing image generation models can be limited in their tailoring to a user's request based on the text provided. Describing specific styles can be difficult, which can cause the image generation model to fail to render a desired scene with a desired style. If multiple style image examples are provided, an image generation model can be fine-tuned to render the specific style; however, fine-tuning can be computationally expensive, time consuming, and may rely on a plurality of example images.

The style-aligned image generation system can obtain and process an input that includes an object image, a style image, and a text description to generate a model-generated style-aligned object image. In particular, the style-aligned image generation system can utilize an image generation model that masks the object of the object image to then generate an embedding of depicted features of the object. The image generation model can process the text description and the style image to render a scene that includes features described by the text description while including the style of the style image. The object can then be rendered into the scene to generate the model-generated style-aligned object image. The style-aligned scene generation can be performed based on a single image and without fine-tuning the model by employing reduced attention sharing during the diffusion process.

Fine-tuning a model for each different style a user wishes to utilize can be computationally expensive, time-consuming, and/or dataset taxing. The style-aligned image generation system can allow for an object (e.g., a product) to be rendered into novel model-generated scenes that are aligned to the style of an example image without the time or computational cost of fine-tuning. Moreover, the style-alignment can be performed based on a single style example image instead of a set of example images that may be relied upon for the fine-tuning alternative.

Users or sets of users (e.g., a brand) can have a particular style and may have limited variance in the images of their products. The style-aligned image generation system can be utilized to render new images of the product in different scenes that are rendered to have the user's style (e.g., the user's aesthetic). The process can be quicker, require less example images, and be less computationally expensive than fine-tuning.

The systems and methods of the present disclosure provide a number of technical effects and benefits. As one example, the systems and methods can provide an image generation system for showcasing an object with different environments and/or objects without the cost and time that is required for traditional photography shoots. The objects can be accurately and realistically rendered in scenes that may not be readily accessible to an individual attempting to generate the object showcase. The image generation can be utilized for product displays, vision boards, art, etc.

Another technical benefit of the systems and methods of the present disclosure is the ability to leverage one or more pre-trained generative models to generate imagery including backgrounds, object ensembles, and showcases that can inspire lifestyle aspirations and aesthetics. The use of pre-trained generative models can reduce the computational resource cost of training new models, which can save time and resources. Additionally, the image generation system can ensure the model-generated image includes an accurate depiction of the qualities of the object with a style transferred from an example style image.

Another example of technical effect and benefit relates to improved computational efficiency and improvements in the functioning of a computing system. For example, the systems and methods disclosed herein can leverage fixed parameter tuning to limit the parameters adjusted for object-specific parameter tuning. In particular, the systems and methods disclosed herein can add new parameters and/or only adjust a set number of parameters of the pre-trained generative model when parameter tuning for accurate object rendering. The parameter tuning can include adjusting one or more parameters of the generative model to accurately and realistically render the particular object. The parameter tuning may be limited to a set of parameters to avoid affecting the quality of other renderings and to reduce the computational cost of retraining the entire model.

With reference now to the Figures, example embodiments of the present disclosure will be discussed in further detail.

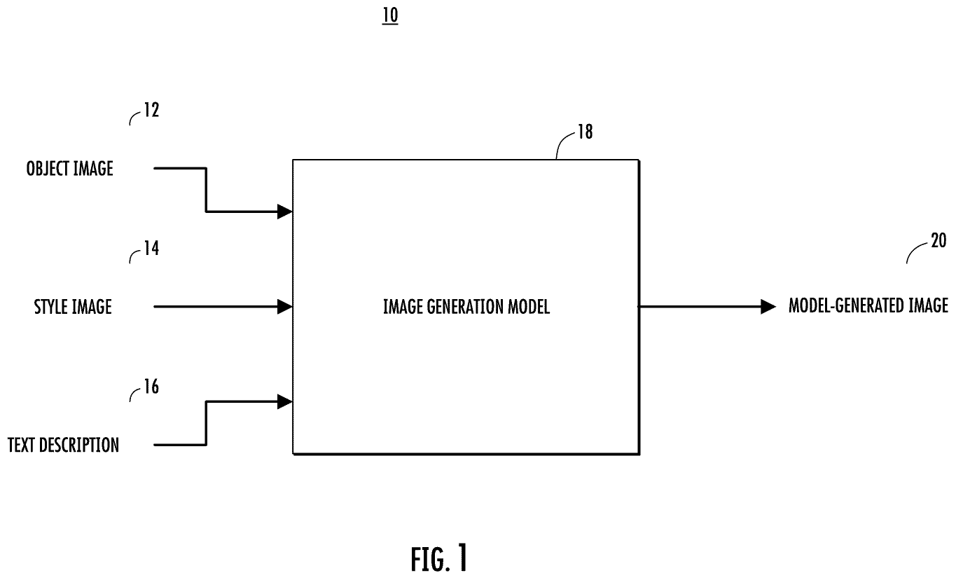

FIG. 1 depicts a block diagram of an example style-aligned image generation system 10 according to example embodiments of the present disclosure. In some implementations, the style-aligned image generation system 10 is configured to receive, and/or obtain, a set of input data that includes an object image 12, a style image 14, and a text description 16 and, as a result of receipt of the input data, generate, determine, and/or provide a model-generated image 20 that depicts the object of the object image 12 rendered into a model-generated environment that includes features requested by the text description 16 and the style of the style image 14. Thus, in some implementations, the style-aligned image generation system 10 can include an image generation model 18 that is operable to perform object masking and delayed and/or reduced attention sharing.

For example, the style-aligned image generation system 10 can obtain an object image 12, a style image 14, and a text description 16. The object image 12 can depict a particular object (e.g., a statue of a cat with a top hat). The style image 14 comprises a particular style (e.g., an image depicting rocks with long shadows in which the image has an orange tone). The text description 16 can include a text string descriptive of a set of requested features to render (e.g., “the statue in the middle of an Inca ruins”).

The image generation model 18 of the style-aligned image generation system 10 can process the object image 12, the style image 14, and the text description 16 to generate a model-generated image 20. The image generation model 18 can include a diffusion model configured, trained, and/or tuned to perform object masking to maintain the original features of the object depicted in the object image. Additionally and/or alternatively, the image generation model 18 can be configured, trained, and/or tuned to include minimal attention sharing during the diffusion process to ensure the image generation model 18 renders the features requested by the text description 16 without generalizing to the non-relevant features of the style image 14.

The style-aligned image generation system 10 can provide the model-generated image 20 as an output. The model-generated image 20 can depict the particular object of the object image 12 rendered into a model-generated scene that includes the style of the style image 14 and the features requested by the text description 16 (e.g., a model-generated image that depicts the statue in an architectural ruins with the architecture of Incan ruins with the image having an orange tone and the ruins and object having long shadows).

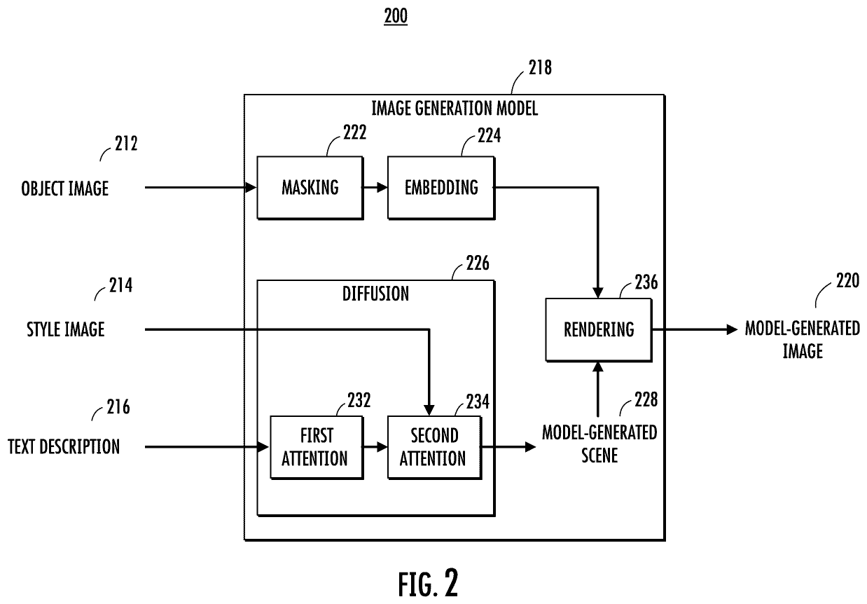

FIG. 2 depicts a block diagram of an example image generation model system 200 according to example embodiments of the present disclosure. The image generation model system 200 is similar to style-aligned image generation system 10 of FIG. 1 except that image generation model system 200 further includes an attention sharing bypass.

For example, the image generation model system 200 can obtain an object image 212, a style image 214, and a text description 216. The object image 212 can depict a particular object (e.g., a color image of John Doe in a tuxedo). The style image 214 comprises a particular style (e.g., a black-and-white image depicting a person sitting on a couch in the corner of the image). The text description 216 can include a text string descriptive of a set of requested features to render (e.g., “John Doe in a throne room with a lion”). The object image 212, the style image 214, and the text description 216 can be obtained via a graphical user interface that may include one or more input interface elements for obtaining the different inputs.

The image generation model 218 of the image generation model system 200 can process the object image 212, the style image 214, and the text description 216 to generate a model-generated image 220. The image generation model 218 can include a diffusion model configured, trained, and/or tuned to perform object masking to maintain the original features of the object depicted in the object image. Additionally and/or alternatively, the image generation model 218 can be configured, trained, and/or tuned to include minimal attention sharing during the diffusion process to ensure the image generation model 218 renders the features requested by the text description 216 without generalizing to the non-relevant features of the style image 214.

The image generation model 218 can process the object image 212 to perform masking 222 to isolate the particular object from the rest of the image data. The isolated object can be processed to perform embedding 224 to generate an object embedding. The object embedding can include a latent representation of the object features.

The image generation model 218 can process the style image 14 and the text description 16 with a diffusion block 226 to generate a model-generated scene 228. The model-generated scene 228 can depict the requested features of the text description 216 with the particular style of the style image 214. The diffusion block 226 can be configured to avoid generalization to the objects of the style image 214 by limiting (or reducing) the attention sharing during the diffusion process. For example, the text description 216 can be processed with a processing pipeline that includes processing with a first attention block 232 and a second attention block 234. The style image 234 can be processed with a processing pipeline that includes avoiding attention sharing at the first attention block 232, while having attention sharing with the text description 216 processing pipeline at the second attention block 234.

The model-generated scene 228 and the object embedding can be processed with a rendering block 236 of the image generation model 220 to generate the model-generated image 220. The rendering block can be configured to augment the model-generated scene 228 rendering to include the particular object in a semantically-aware rendering. The particular object can be rendered with ground truth proportions and coloring based on the object embedding.

The image generation model system 200 can provide the model-generated image 220 as an output. The model-generated image 220 can depict the particular object of the object image 212 rendered into a model-generated scene that includes the style of the style image 214 and the features requested by the text description 216 (e.g., a model-generated image that depicts John Doe sitting on a throne next to a lion with a black-and-white filter to the image).

The model-generated image 220 can be provided for display in the graphical user interface. In some implementations, the model-generated image 220 can be provided for display with other model-generated images.

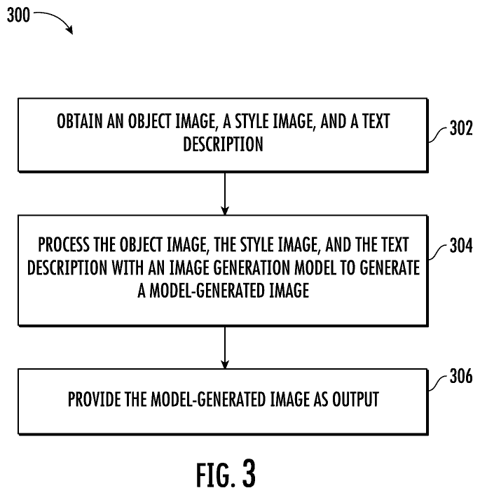

FIG. 3 depicts a flow chart diagram of an example method to perform according to example embodiments of the present disclosure. Although FIG. 3 depicts steps performed in a particular order for purposes of illustration and discussion, the methods of the present disclosure are not limited to the particularly illustrated order or arrangement. The various steps of the method 300 can be omitted, rearranged, combined, and/or adapted in various ways without deviating from the scope of the present disclosure.

At 302, a computing system can obtain an object image, a style image, and a text description. The object image can depict a particular object. The style image can include a particular style. The text description can include a request for a scene including one or more particular features. In some implementations, the particular style of the style image can include at least one of a specific image saturation, a specific contrast, a specific lighting, a specific filter, or a specific visual effect. The particular object can include a product, a person, a structure, a plant, an animal, and/or other type of the object. The style image may include a raw image, an augmented image, and/or a synthetic image. The text description may be generated based on an audio input via a transcription generation technique and/or a semantic understanding of an audio processing model. In some implementations, the text description may be generated based on a plurality of user selections of a plurality of user interface elements.

In some implementations, obtaining the style image can include obtaining metadata associated with a user, determining a web resource associated with the metadata, and determining a particular content item from the web resource to obtain as the style image. The metadata may include data descriptive of a user identifier, an entity associated with the user, a search instance entity tag, a time of user interface invocation by the user, a time the text description was input, a caption associated with a previous style image utilized by the user, a source of a previous style image, and/or other metadata. The web resource may be a web page associated with an entity associated with the user. The web page can depict a plurality of brand images that may depict different products, slogans, and/or other features. The style image can include one of the brand images and/or may be generated based on a plurality of different brand images being processed (e.g., via style distillation, which may include image concatenation and/or diffusion processing).

At 304, the computing system can process the object image, the style image, and the text description with an image generation model to generate a model-generated image. The model-generated image can depict the particular object within a model-generated scene that includes the one or more particular features. The model-generated image can include the particular style. In some implementations, the image generation model can include a diffusion model trained to generate novel images based on processing a text string. The image generation model can generate the model-generated image by: generating an object mask based on the object image, generating an object embedding based on the object image and the object mask, generating a model-generated scene based on the style image and the text description, and generating the model-generated image based on the model-generated scene and the object embedding.

The image generation model can generate an object mask based on the object image. The object mask can be descriptive of a silhouette of the particular object depicted in the object image. The object mask may be generated based on object detection and/or image segmentation processing. In some implementations, the image generation model may include and/or be communicatively connected to an object detection model, an object recognition model, a segmentation model, and/or other machine-learned model for mask generation. The object mask may be a segmentation mask.

The image generation model can generate an object embedding based on the object image and the object mask. The object embedding can be descriptive of a plurality of object features. In some implementations, the object mask and object embedding can be generated with an encoder of the image generation model. The object embedding can include a learned probability distribution associated with a plurality of color values and a plurality of opacity values. In some implementations, the object embedding can be generated by segmenting the pixels associated with the particular object from other pixels from the object image and processing the segmented object with an embedding model to generate the object embedding. The object embedding may include a vector representation descriptive of object features depicted in the object image. In some implementations, the object embedding may include learned rendering weights or values associated with rendering the particular object. The object embedding may be associated with a learned radiance field probability distribution.

The image generation model can generate a model-generated scene based on the style image and the text description. The model-generated scene can include pixel data descriptive of the one or more particular features requested by the text description. The model-generated scene can include the particular style of the style image. In some implementations, generating a model-generated scene based on the style image and the text description can include performing an attention sharing bypass during the diffusion process. The image generation model can perform adaptive instance normalization during model-generated scene generation. Adaptive instance normalization can be performed by a set of adaptive instance normalization blocks (e.g., a set of layers) that aligns the mean and variance of the content features with those of the style features. The model-generated scene can be generated without fine-tuning the image generation model on a plurality of training images that includes the particular style of the style image. In some implementations, the model-generated scene may include a model-generated background.

In some implementations, the image generation model can include a transformer model. The model-generated scene can be generated based on allowing target features of the style image to bypass at least a portion of a self-attention block of the transformer model. In particular, the model-generated scene may be generated with minimal attention sharing during the diffusion process.

The image generation model can generate the model-generated image based on the model-generated scene and the object embedding. The model-generated image can include the particular object rendered into the model-generated scene. The model-generated image can include a plurality of predicted pixels that are rendered based on a plurality of sequence predictions. In some implementations, the model-generated image can include a novel image, a novel scene, a novel composition, and/or other novel features.

At 306, the computing system can provide the model-generated image as output. The model-generated image may be provided for display in a graphical user interface that may provide the model-generated image for display with a plurality of other model-generated images. In some implementations, the plurality of other model-generated images may have been generated in parallel to the model-generated image. The graphical user interface may include a dialogue interface that provides the inputs and outputs as dialogue that attributes each content item in a historical log. The model-generated image may be provided for display with the object image, the product image, and/or the text description. In some implementations, the model-generated image may be published on a web page requested by the user that input the input data.

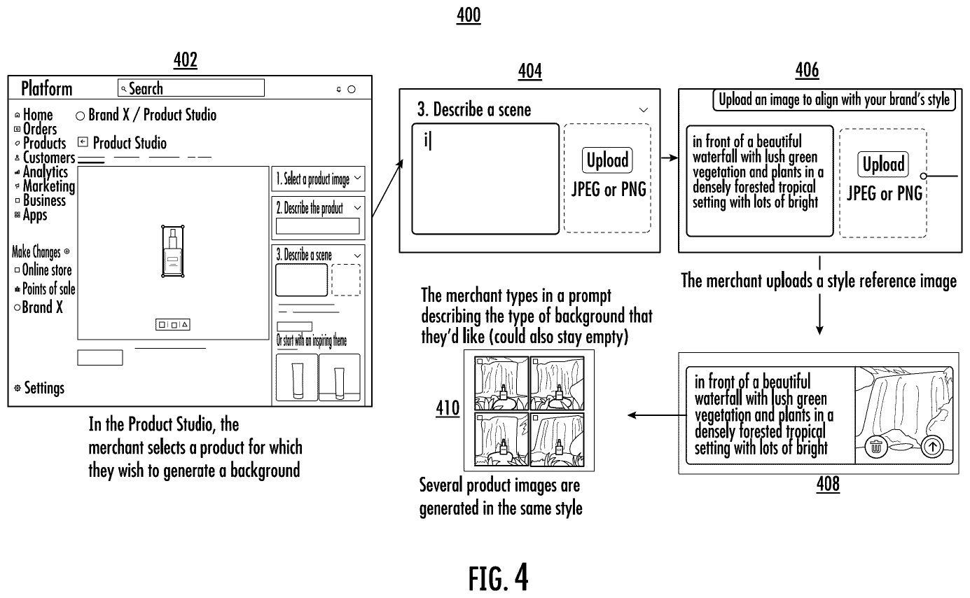

FIG. 4 depicts illustrations of an example generation studio interface 400 according to example embodiments of the present disclosure. In particular, FIG. 4 depicts a generation studio interface 400 that includes a multi-stage and/or multi-portion interface that can be leveraged to obtain the inputs and then provide the outputs for display.

For example, at 402, the generation studio interface 400 can obtain and provide for display the object image, which may be obtained from a catalog of object images provided by the user. At 404, the generation studio interface 400 can provide a text input box for obtaining the text description input. At 406, the generation studio interface 400 can provide an upload interface feature for a user to upload and/or select a style image to utilize. At 408, the generation studio interface 400 can provide for display the text description with an initial model-generated scene rendering. At 410, the generation studio interface 400 can provide a plurality of model-generated images for display.

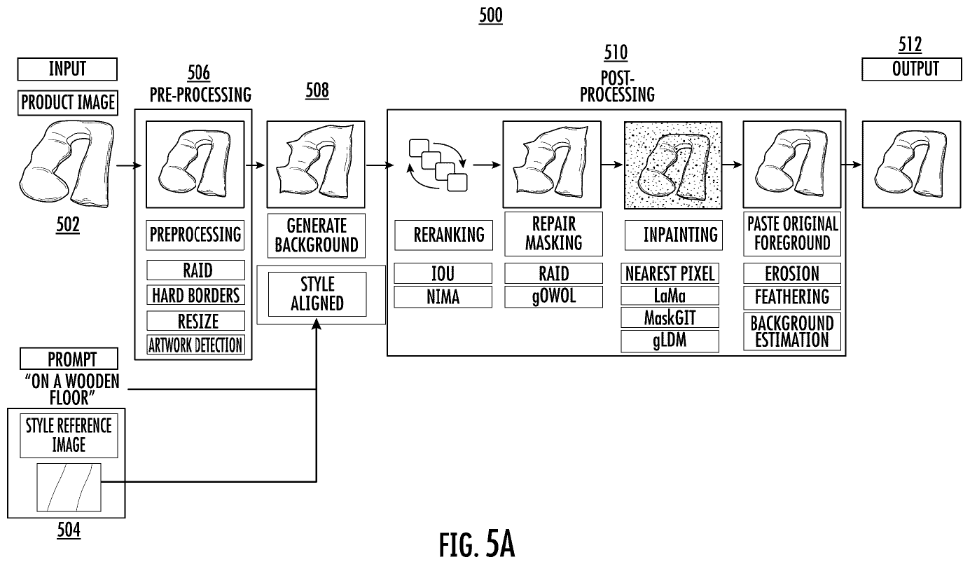

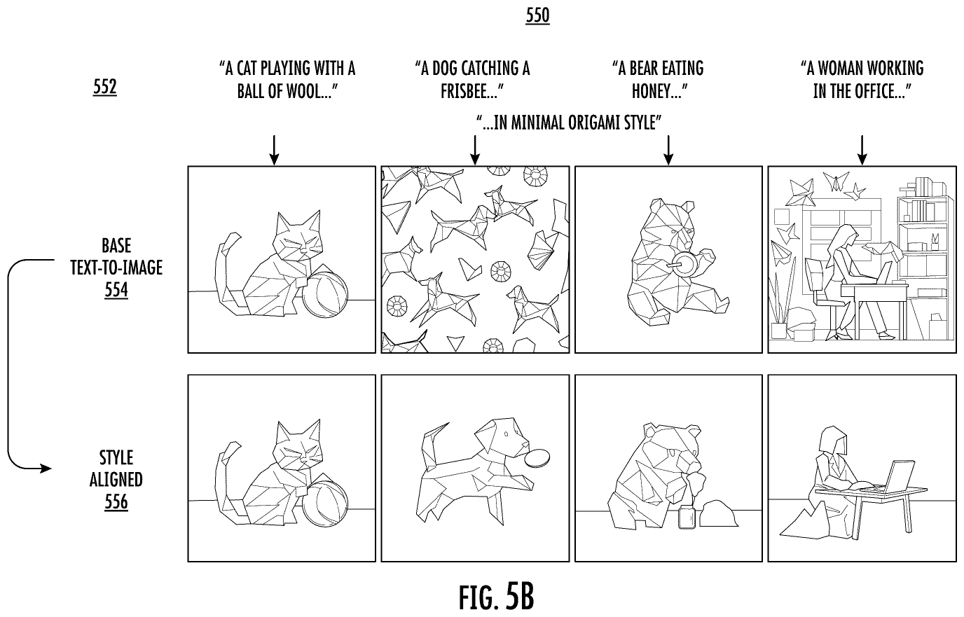

FIG. 5A depicts a block diagram of an example processing pipeline 500 according to example embodiments of the present disclosure. In particular, an object image 502 (e.g., a product image) can be processed with a pre-processing block 506 to configure the image data for the image generation processing. The pre-processing block 506 can include file size adjustment, image proportion adjustments, cropping, object detection, image segmentation, image augmentation, and/or other techniques.

A prompt and style image 504 can be processed to generate a model-generated background 508 via style-alignment processing, which can allow for the style transfer of the style image, while mitigating inference with the text-to-image generation processing.

A post-processing block 510 can process the model-generated background 508 and the output of the pre-processing block 506 in order to generate a model-generated image 512 as output. The post-processing block 510 can include ranking a plurality of candidate model-generated scenes in order to select a particular model-generated background to utilize. The masking repair and inpainting can be performed to render the object within the model-generated background 508.

FIG. 5B depicts illustrations of example style-aligned images 550 according to example embodiments of the present disclosure. In particular, FIG. 5B depicts example text prompts 552 (e.g., example text descriptions), example vanilla text-to-image generation outputs 554, and example style-aligned generation outputs 556. As depicted, the example style-aligned generation outputs 556 can be generated to have a style of a particular style image, while performing the rendering requested by the text prompt 552.

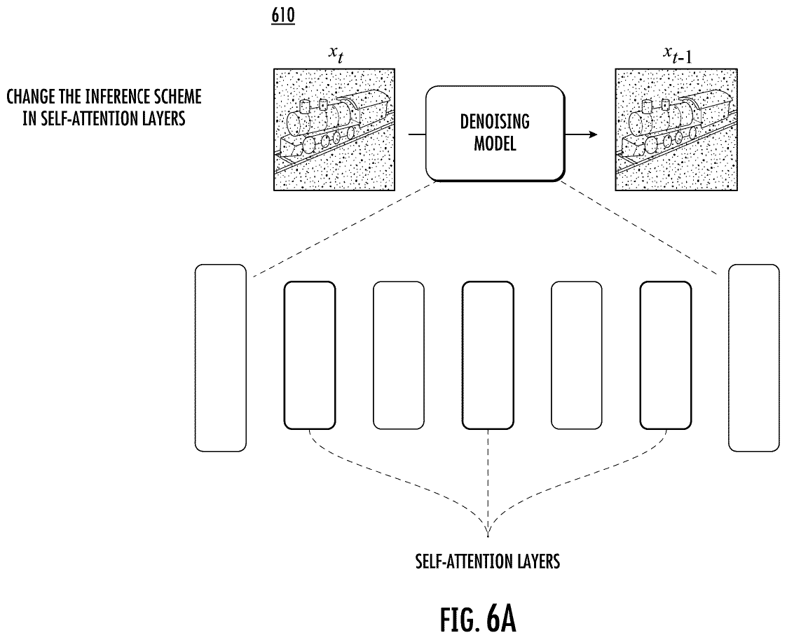

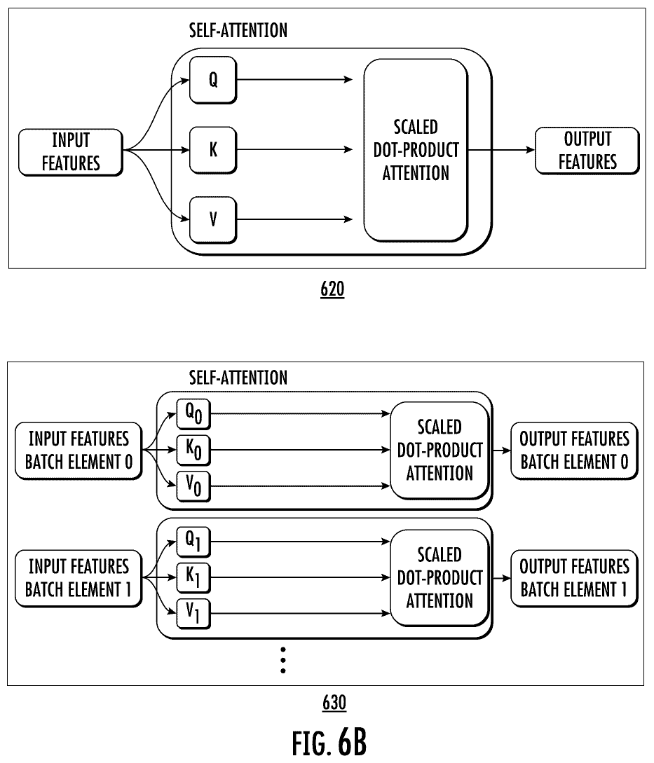

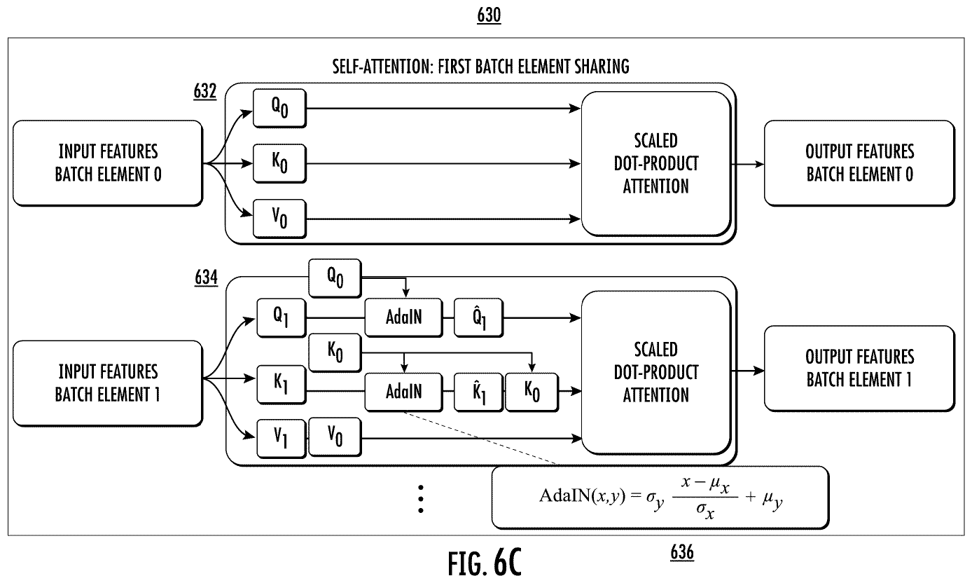

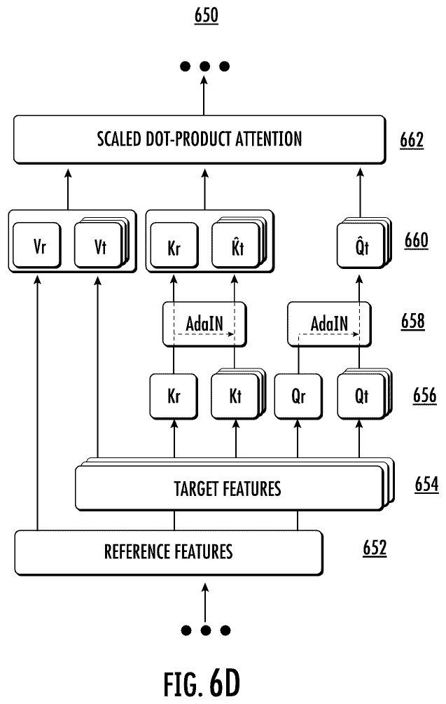

FIG. 6A depicts a block diagram of an example self-attention inference system 610 according to example embodiments of the present disclosure. In particular, the self-attention inference system 610 can include a plurality of self-attention layers for denoising images based on previous image inferences.

FIG. 6B depicts block diagrams of example vanilla self-attention schemes according to example embodiments of the present disclosure. In particular, the first vanilla scheme 620 can include a plurality of input feature processing pipelines that are then processed with a scaled dot-product attention block to generate output features. In the second vanilla scheme 630, the self-attention can be performed in a plurality of batches that may be processed in isolation.

FIG. 6C depicts a block diagram of an example shared self-attention system 630 according to example embodiments of the present disclosure. In particular, the shared self-attention system 630 can perform a first attention sharing processing 632 to generate a first batch output. The subsequent processing 634 can perform adaptive attention sharing based on the first attention sharing processing 632. The adaptive attention sharing can include adaptive instance normalization 636.

FIG. 6D depicts a diagram of an example shared self-attention system with target-reference attending 650 according to example embodiments of the present disclosure. In particular, the shared self-attention system with target-reference attending 650 can process a target image and a reference image to generate a model-generated image that includes object(s) from the target image depicted in the style of the reference image.

For example, a target image depicting one or more objects and a reference image depicting different objects in a particular style can be obtained. The target image can be processed to determine a plurality of target features 654. The reference image can be processed to determine a plurality of reference features 652. The features can then be projected into queries (Q), keys (K), and values (V) through learned block parameters (e.g., learned linear layers). Each of queries (Q), keys (K), and values (V) can be vectors leveraged by the attention block for pixel/pixel set representation (or identification). The features may be updated based on a weighted sum of the values (V) in which the weight can depend on a correlation between the respective projected query (q) and keys (K).

As depicted in FIG. 6D, the queries and keys 656 associated with the reference features 652 and target features 654 can be processed with one or more normalization blocks 658 to perform adaptive instance normalization to output 660 the reference keys, the normalized target keys, and the normalized queries.

In some implementations, the values (V) associated with the reference features 652 and target features 654 can bypass the normalization blocks 658. The reference values, the target values, the reference keys, the normalized target keys, and the normalized queries can then be processed with the attention block 662 (e.g., a scaled dot-product attention block) to generate prediction data that can then be processed to render the model-generated image.

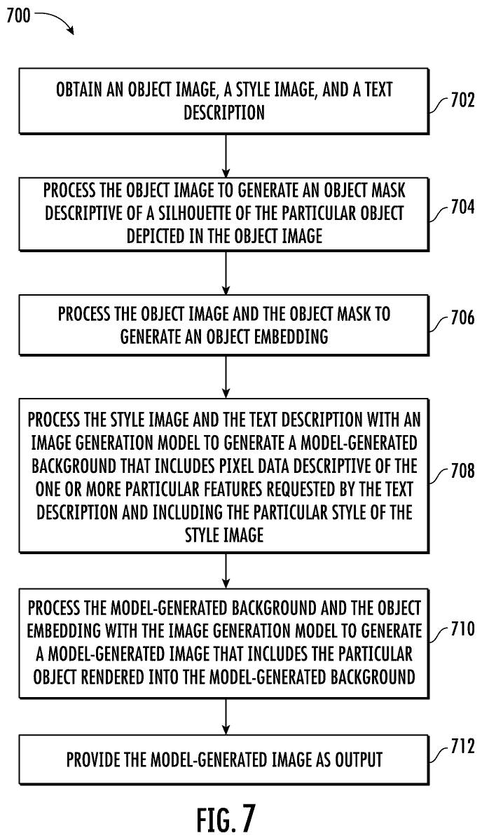

FIG. 7 depicts a flow chart diagram of an example method to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can obtain an object image, a style image, and a text description. The object image can depict a particular object. The style image can include a particular style. The text description can include a request for a background including one or more particular features. The particular style of the style image may include a specific composition of the style image. In particular, target features of the style image may be assorted in a particular configuration. For example, the style image may include lighting, coloring, distortion, and/or objects in a particular configuration, where a first feature is in a particular position relative to a second feature and/or an image border.

In some implementations, the text description can be based on an input search query input by a user. The object image can be at least one of: determined based on performing a search with at least a portion of the input search query or input with the input search query by the user. The style image can be determined based on a context associated with the input search query being input. For example, a user catalog of images may be determined and may be leveraged to determine, obtain, and/or generate the style image.

In some implementations, obtaining the style image can include obtaining a plurality of example images associated with a user, generating an image cluster based on determining at least a subset of the plurality of example images includes a shared style, and generating the style image based on the image cluster. For example, the images of the image cluster may be processed by a generative model (e.g., a diffusion model) and/or an augmentation model (which may leverage concatenation and/or machine-learned weights) to generate an example style image that distills the determined shared style images into a single image. The approach can reduce generalizations to irrelevant features that may only be in one or a few of the images.

At 704, the computing system can process the object image to generate an object mask descriptive of a silhouette of the particular object depicted in the object image. The object mask can include a plurality of pixel-based coordinate positions associated with the object image to indicate the outline of the particular object. In some implementations, the object mask can be utilized to generate a three-dimensional rendering of the particular object.

At 706, the computing system can process the object image and the object mask to generate an object embedding. The object embedding can be descriptive of a plurality of object features. In some implementations, the object embedding may include a vector representation descriptive of three-dimensional features of the particular object, which may be determined based on neural radiance field-based inference.

At 708, the computing system can process the style image and the text description with an image generation model to generate a model-generated background that includes pixel data descriptive of the one or more particular features requested by the text description and including the particular style of the style image. The model-generated background can include a desert with particular plants and/or animals, a room with particular furniture and/or wall décor, a street with buildings having particular architecture and/or vehicles, and/or other environmental features rendered based on the text description. The composition, coloring, lighting, saturation, filters, and/or other style attributes can be rendered applied based on the particular style of the style image.

At 710, the computing system can process the model-generated background and the object embedding with the image generation model to generate a model-generated image that includes the particular object rendered into the model-generated background. The model-generated image can depict the particular object with the geometry and coloring that is consistent with the geometry and coloring of the particular object as depicted in the object image if provided with the style of the style image.

At 712, the computing system can provide the model-generated image as output. The model-generated image may be provided for display in a carousel interface with a plurality of other model-generated images. The mode-generated image may be downloaded to a user computing device and/or uploaded to a user database and/or web platform.

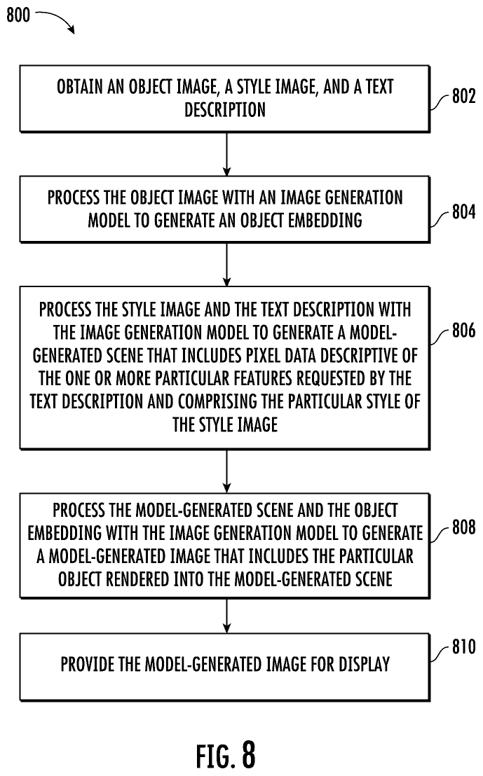

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can obtain an object image, a style image, and a text description. The object image can depict a particular object. The style image can include a particular style. The text description can include a request for a scene comprising one or more particular features. The object image, style image, and/or text description may be obtained via a graphical user interface that may include a freeform text input box and/or an image upload interface element, which may include an upload button, drag-and-drop space, and/or a URL input box.

At 804, the computing system can process the object image with an image generation model to generate an object embedding. The object embedding can be generated by: generating an object mask descriptive of a silhouette of the particular object depicted in the object image and generating the object embedding based on the object image and the object mask. The object embedding can be descriptive of a plurality of object features. The image generation model may be configured, tuned, and/or trained to perform that mask embedding processing.

At 806, the computing system can process the style image and the text description with the image generation model to generate a model-generated scene that includes pixel data descriptive of the one or more particular features requested by the text description and comprising the particular style of the style image. In some implementations, the model-generated scene can be generated without fine-tuning the image generation model on the particular style of the style image. The model-generated scene can differ from a first scene depicted in the object image. The model-generated scene may differ from a second scene depicted in the style image. In some implementations, the particular object can differ from the plurality of objects depicted in the style image. The image generation model can include a generative text-to-image model that was pre-trained to generate a plurality of pixel predictions based on an input text string.

At 808, the computing system can process the model-generated scene and the object embedding with the image generation model to generate a model-generated image that includes the particular object rendered into the model-generated scene. The image generation model may perform diffusion-based predictions for generating the model-generated scene and may perform image inpainting and/or neural radiance field-based rendering for rendering the particular object for the generation of the model-generated image.

At 810, the computing system can provide the model-generated image for display. The display of the model-generated image may be performed based on a web platform interface feature that provides a preview window that displays the model-generated image before upload and/or download. The model-generated image may be utilized as a frame of a model-generated video. For example, the systems and methods disclosed herein may be utilized to complement real world images and/or may be utilized to generate a plurality of model-generated images to generate a model-generated video that can showcase a particular object in a requested environment with a particular style.

Large-scale text-to-image (T2I) models can excel across creative fields, generating visually compelling outputs from textual prompts. However, controlling these models to ensure consistent style can be challenging, with existing methods necessitating fine-tuning and manual intervention to disentangle content and style. In this paper, the systems and methods disclosed herein can be designed to establish style alignment among a series of generated images. By employing minimal ‘attention sharing’ during the diffusion process, the systems and methods can maintain style consistency across images within T2I models. The approach can allow for the creation of style-consistent images using a reference style through a straightforward inversion operation. The method's evaluation across diverse styles and text prompts can demonstrate high-quality synthesis and fidelity, underscoring the efficacy in achieving consistent style across various inputs.

Large-scale Text-to-Image (T2I) generative models can be utilized for art, graphic design, animation, architecture, gaming, and other creative tasks. The models can show tremendous capabilities of translating an input text into an appealing visual result that is aligned with the input description.

In some implementations, the application of T2I models can revolve around the rendition of various concepts in a way that shares a consistent style and character, as though all were created by the same artist and method. While proficient in aligning with the textual description of the style, the T2I models may generate images that diverge significantly in their interpretations of the same stylistic descriptor.

In some implementations, systems may mitigate the divergence by fine-tuning the T2I model over a set of images that share the same style. However, optimization can be computationally expensive and may be reliant on human input in order to find a plausible subset of images and texts that enables the disentanglement of con-tent and style.

The systems and methods disclosed herein can enable consistent style interpretation across a set of generated images. The systems and methods can require no optimization and can be applied to any attention-based text-to-image diffusion model. Adding minimal attention sharing operations along the diffusion process, from each generated image to the first one in a batch, can lead to a style-consistent set. Moreover, using diffusion inversion, the systems and methods can be applied to generate style-consistent images given a reference style image, with no optimization or fine-tuning.

The systems and methods can generate results over diverse styles and text prompts, demonstrating high-quality synthesis and fidelity to the prompts and reference style. The systems and methods can generate diverse examples of generated images that share their style with a reference image that can possibly be a given input image. The systems and methods can be utilized as a zero-shot solution, distinct from other personalization techniques, as the system can operate without any form of optimization or fine-tuning.

The systems and methods can include a self-attention mechanism. In some implementations, the systems and methods can include attention-sharing operation within the self-attention layers that enable style aligned image set generation.

Diffusion models can include generative latent variable models that aim to model a distribution p_{θ}(x₀) that approximates the data distribution q(x₀) and are easy to sample from. Diffusion models can be trained to reverse the diffusion “forward process”:

$${x}_{t} = \sqrt{{α}_{t}} {x}_{0} + \sqrt{1 - {α}_{t}} ϵ , ϵ \sim N ( 0 , I ) ,$$

where t∈[0, ∞) and the values of αₜ are determined by a scheduler such that α₀=1 and

$${lim}_{t \to ∞} {α}_{t} = 0.$$

During inference, an image can be sampled by gradually denoising an input noise image x_{T}˜ [symbol] (0, l) via the reverse process:

$${x}_{t - 1} = {μ}_{t - 1} + {σ}_{t} z , z \sim N ( 0 , I ) ,$$

where the value σₜ can be determined by the sampler and μₜ₋₁ is given by

$${μ}_{t - 1} = \frac{\sqrt{{α}_{t - 1}} {x}_{t}}{\sqrt{{α}_{t}}} + ( \sqrt{1 - {α}_{t - 1}} - \frac{\sqrt{1 - {α}_{t}}}{\sqrt{{α}_{t}}} ) {ϵ}_{θ} ( {x}_{t} - t ) ,$$

where ϵ_{θ}(xₜ, t) can be the output of a diffusion model parameterized by θ.

Moreover, the process can be generalized for learning a marginal distribution using an additional input condition. The generalization can lead text-to-image diffusion models (T2I), where the output of the model ϵ_{θ}(xₜ, t, y) can be conditioned on a text prompt y.

Self-Attention in T2I Diffusion Models can employ a U-Net architecture that includes convolution layers and transformer attention blocks. In these attention mechanisms, deep image features φ∈ [symbol] can attend to each other via self-attention layers and to contextual text embedding via cross-attention layers.

The self-attention layers can be where deep features are being updated by attending to each other. First, the features can be projected into queries Q∈m×dₖ, keys K∈m×dₖ and values V∈m×dₕ through learned linear layers. Then, the attention can be computed by the scaled dot-product attention:

$$Attention ( Q , K , V ) = softmax ( \frac{{QK}^{T}}{\sqrt{{d}_{k}}} V )$$

where dₖ can be the dimension of Q and K. Each image feature can be updated by a weighted sum of V, where the weight can depend on the correlation between the projected query q and the keys K. In practice, each self-attention layer can include several attention heads, and then the residual can be computed by concatenating and projecting the attention heads output back to the image feature space dₕ:

$$ϕ = ϕ + Multi - Head - Attention ( ϕ ) .$$

The method can be utilized to generate a set of images 1 . . . n that are aligned with an input set of text prompts y₁ . . . yₙ and share a consistent style interpretation with each other. For example, images can be generated that include an aligned style that depict different objects such that the images are style-aligned with each other. One way to generate a style aligned image set of different content can be to use the same style description in the text prompts. Generating different images using a shared style description of “in minimal origami style” can result in an unaligned set, since each image is unaware of the exact appearance of other images in the set during the generation process.

The systems and methods disclosed herein can utilize the self-attention mechanism to allow communication among various generated images. The communication can be achieved by sharing attention layers across the generated images.

Formally, let Qᵢ, Kᵢ, and Vᵢ be the queries, keys, and values, projected from deep features φᵢ of i in the set, then, the attention update for φᵢ is given by:

$$Attention ( {Q}_{i} , {K}_{1 … n} , {V}_{1 … n} ) , \qquad ( 1 )$$

where

$${K}_{1 … n} = [ \begin{matrix}{K}_{1} \\ {K}_{2} \\ ⋮ \\ {K}_{n}\end{matrix} ] and {V}_{1 … n} = [ \begin{matrix}{V}_{1} \\ {V}_{2} \\ ⋮ \\ {V}_{n}\end{matrix} ] .$$

However, by enabling full attention sharing, the full-attention system may harm the quality of the generated set. In some implementations, full attention sharing can result in content leakage among the images. Moreover, full attention sharing can result with less diverse sets of the same set of prompts.

To restrict the content leakage and allow diverse sets, the system can share the attention to only one image in the generated set (typically the first in the batch). That is, target image features φₜ can be attending to themselves and to the features of only one reference image in the set using Eq. 1. Sharing the attention to only one image in the set can result in diverse sets that share a similar style. However, in that case, the style of different images may not be well aligned. The lack of alignment may be due to low attention flow from the reference to the target image.

To enable balanced attention reference, the system may normalize the queries Qₜ and keys Kₜ of the target image using the queries Qᵣ and keys Kᵣ of the reference image using the adaptive normalization operation (AdaIN) [26]:

$$= AdaIN ( {Q}_{t} , {Q}_{r} )$$

$$= AdaIN ( {K}_{t} , {K}_{r} ) ,$$

where the AdaIn operation is given by:

$$AdaIN ( x , y ) = σ ( y ) ( \frac{x - μ ( x )}{σ ( x )} ) + {μ}_{y} ,$$

and μ(x), σ(x)∈ [symbol] are the mean and the standard deviation of queries and keys across different pixels. Finally, the shared attention may be given by Attention

$$( {\hat{Q}}_{t} , {K}_{rt}^{T} , {V}_{rt} ) ,$$

where

$${K}_{rt} = [ \begin{matrix}{K}_{r} \\ {K}_{t}\end{matrix} ] and {V}_{rt} = [ \begin{matrix}{V}_{r} \\ {V}_{t}\end{matrix} ] .$$

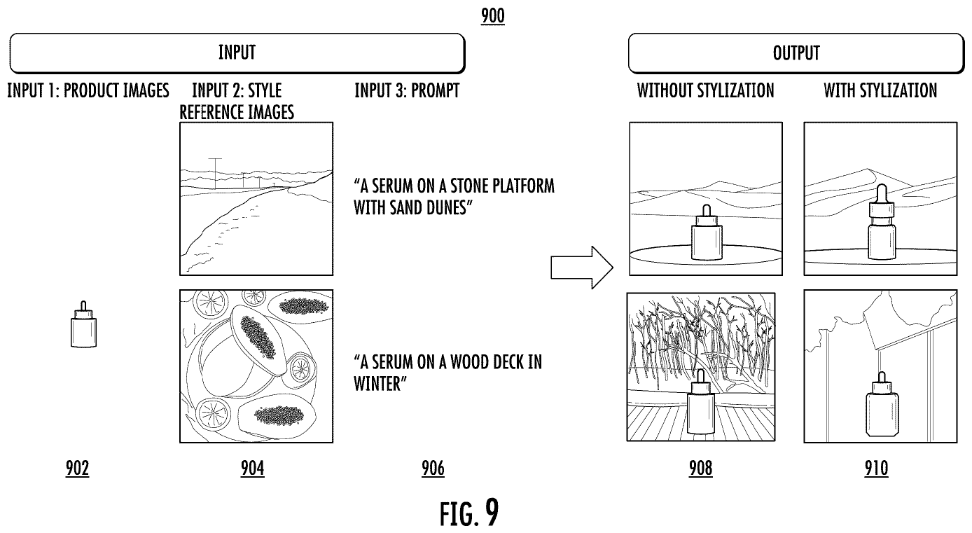

FIG. 9 depicts illustrations of example inputs and outputs 900 according to example embodiments of the present disclosure. In particular, FIG. 9 depicts an example set of inputs and an example set of outputs. The example set of inputs includes an example object image 902, example style images 904, and example prompts 906. The example set of outputs includes outputs without stylization 908 and outputs with stylization 910. As depicted, the outputs with stylization 910 can differ from the outputs without stylization 908 as the coloring, saturation, and/or perspective can be adjusted based on the stylization inferred from the example style images 904.

In some implementations, the systems and methods disclosed herein can be directed to optimization of machine-learned models. More particularly, the present disclosure can relate to optimizing generative models for subject-driven text-to-3D data generation. For example, as described previously, the generation of three-dimensional representations from textual prompts, and/or from two dimensional images, has recently been explored. However, such models have suffered from overfitting of viewpoint. In other words, such generative models exhibit relatively poor performance when generating viewpoints of subjects that are not present in any images provided as input to the models.

Accordingly, implementations of the present disclosure propose optimization of generative machine-learned models for more accurate, subject-driven text-to-3D asset generation. For example, a fractional training process can be performed with a plurality of training images to partially train an instance of a machine-learned generative image model. The machine-learned generative image model can be a model trained to generate images from a textual prompt. The machine-learned generative image model can be partially trained by stopping the training process before the model is fully optimized (e.g., a “fractional” training process). For example, if performing a number M training iterations would optimize the machine-learned generative image model to a sufficient degree, performing the fractional training process would include performing a number of training iterations N that is less than M.

A fractional optimization process can be performed with the partially trained instance of the machine-learned generative image model to an instance of a machine-learned 3D implicit representation model. By doing so, a partially optimized instance of the machine-learned 3D implicit representation model can be obtained. The machine-learned 3D implicit representation model can be a model trained to generate novel representations (e.g., implicit three-dimensional representations) of a three-dimensional scene depicted by a set of images. The fractional optimization process can be performed to the machine-learned 3D implicit representation model in a similar manner to the fractional training process described previously.

Based on the plurality of training images, the partially optimized instance of the machine-learned 3D implicit representation model and a fully trained instance of the machine-learned generative image model can be used to generate a plurality of pseudo multi-view subject images. The partially trained instance of the machine-learned generative image model can be trained with a set of training data that includes the plurality of pseudo multi-view subject images and the plurality of training images to obtain a machine-learned multi-view image model. The machine-learned multi-view image model can be used to optimize the partially optimized instance of the machine-learned 3D implicit representation model to obtain a further optimized instance of the machine-learned 3D implicit representation model. In such fashion, implementations of the present disclosure can perform a series of operations to optimize a series of models for more accurate and efficient generation of 3D assets.

Aspects of the present disclosure provide a number of technical effects and benefits. As one example technical effect and benefit, conventional generative models for 3D assets are relatively inaccurate. Due to their inaccuracy, the practical applications of such models are relatively limited. However, implementations of the present disclosure can optimize generative models to generate 3D assets much more accurately. The outputs of these models, once optimized, are sufficiently accurate for utilization in a variety of use cases, such as 3D asset generation for multimedia applications (e.g., video games, etc.), rapid prototyping, etc. As such, in some circumstances, implementations of the present disclosure can eliminate, or substantially reduce, the need to create 3D assets by hand, which requires a substantial expenditure of resources (e.g., time, power, memory, compute cycles, bandwidth, etc.).

The computing system can include one or more processors and one or more non-transitory computer-readable media that store instructions that, when executed by the one or more processors, cause the one or more processors to perform operations. The operations can include performing a fractional training process with a plurality of training images to an instance of a machine-learned generative image model to obtain a partially trained instance of the machine-learned generative image model. The machine-learned generative image model can be partially trained to generate images from a textual prompt. The operations can include performing a fractional optimization process with the partially trained instance of the machine-learned generative image model to an instance of a machine-learned three-dimensional (3D) implicit representation model to obtain a partially optimized instance of the machine-learned 3D implicit representation model. The machine-learned 3D implicit representation model can be trained to generate novel representations of a scene depicted by a set of images. The operations can include, based on the plurality of training images, generating a plurality of pseudo multi-view subject images with the partially optimized instance of the machine-learned 3D implicit representation model and a fully trained instance of the machine-learned generative image model. The operations can include training the partially trained instance of the machine-learned generative image model with a set of training data comprising the plurality of training images and the plurality of pseudo multi-view subject images to obtain a machine-learned multi-view image model. The operations can include optimizing the partially optimized instance of the machine-learned 3D implicit representation model with the machine-learned multi-view image model to obtain a further optimized instance of the machine-learned 3D implicit representation model.

In some implementations, the systems and methods can be directed to generating novel renderings of an object in different environments. One or more images of the object can be utilized to train a set of parameters to generate renderings of the object in output images. The set of parameters and a generative image generation model can then be utilized to generate a plurality of images of the particular object in one or more environments that may differ from the environments depicted in the input images.

For example, a set of input images depicting an object can be received. The set of input images can include the object from different angles and/or in different environments. The set of input images can be utilized to adjust one or more parameters of a generative model (e.g., a text-to-image generative model) to train the generative model to render that specific object. The tuned generative model can then be utilized to generate a plurality of model-generated images that depict the object in different environments, which can include different locations, lighting, and/or with different objects. The generation of the model-generated images may be based on a prompt provided to and processed with the tuned generative model. The prompt may include a unique identifier associated with the object and/or may include a request for a particular environment to render the objects in for the model-generated images.

The generative model may be conditioned for one object or a set of objects, which can be utilized to generate model-generated images that include an ensemble of the objects in one or more environments. The tuned generative model may be utilized to generate novel view renderings of the object and/or for depicting the object in different lighting.

The systems and methods disclosed herein can be utilized to showcase an object and/or a set of objects in different environments with different backgrounds (e.g., different settings) and/or different additional objects (e.g., different object ensembles). The object can be rendered accurately and realistically while being displayed in various environments that may inspire a user to utilize the object in a particular location and/or in a particular manner. In particular, the systems and methods can use computer vision and machine learning (e.g., object shape/pose/reflectance estimation, object-conditioned generative models, etc.) to automatically generate hero/showroom images at scale, and in a personalizable and targetable manner.

Viewing an object in different scenes and/or with other objects can inspire a user. The user may be inspired to obtain and/or use an object for a particular task based on how an object is displayed in an image and/or with what an object is displayed within an image. For example, product placement can be utilized to market different products and can provide users with an imagined use and/or location of use for the given product. Marketing campaigns can be expensive and time consuming, which may lead to limited diversity in the images of particular products. Additionally, generative model image generation can cause some objects and/or details to be rendered irregularly. For example, the size proportions may be rendered inaccurately, and/or artifacts and/or other abnormalities may be rendered. For instances in which a user desires an object to be rendered accurately as a showcase for the object, traditional generative models alone may not provide a desired outcome.

The systems and methods disclosed herein can depict an object and/or a plurality of objects in different scenes and/or with different objects without the time consumption and/or cost of physically setting up, scheduling, and performing a photography shoot. Additionally and/or alternatively, the systems and methods disclosed herein can provide object showcasing to individuals that may not traditionally be able to access the locations and/or costs utilized in traditional object showcasing.

Additionally and/or alternatively, the systems and methods disclosed herein can obtain one or more images of an object, obtain a pre-trained generative model (e.g., a pre-trained image generation model), and generate a specialized generative model that is specialized to render the object(s) in different environments. The generation of the specialized generative model can include adding and tuning additional parameters to the pre-trained generative model and/or adjusting a limited number of parameters of the pre-trained generative model to generate accurate and realistic renderings of the object(s). The object-specific parameter tuning can mitigate proportion inaccuracies and/or artifacts when rendering the object, while continuing to leverage the predictive capabilities of the pre-trained generative model.

In some implementations, one or more input images of a particular object can be obtained and processed with a pre-trained image generation model to generate a plurality of output model-generated images (e.g., synthetic images that include predicted pixel data) that include the particular object in one or more environments. The one or more environments of the plurality of output model-generated images can differ from the one or more background environments of the one or more input images. One or more particular output model-generated images of the plurality of output model-generated images may be selected for output based on an object metric that measures the similarity between the object of the input images and the rendered object in the respective output model-generated image. Additionally and/or alternatively, one or more particular output model-generated images of the plurality of output model-generated images may be selected for output based on a realism metric that can be descriptive of a determined realism of a respective output model-generated image of the plurality of output model-generated images.

Additionally and/or alternatively, parameters of the image generation model and/or separate parameters may be tuned (e.g., adjusted) based on the one or more input images to train the system to render that particular object. The tuning can be based on a loss function that compares an output model-generated image against one or more input images. One or more of the plurality of output model-generated images may be obtained and provided to a user computing system in response to receiving a search query that is determined to be associated with the particular object. Alternatively and/or additionally, one or more of the plurality of output model-generated images may be obtained and provided to a user computing system in response to receiving content data that is determined to be associated with the particular object. The content data can be descriptive of one or more content items accessed by the user computing system. The input images may include multiple sets of images associated with multiple objects to be rendered. In response to processing the multiple sets of images, the multiple objects may be rendered together in the output model-generated images. The image generation model (e.g., a text-to-image generative model and/or image-to-image generative model) can include a diffusion model and/or a token-based transformer model.

In some implementations, a plurality of input images descriptive of an object can be obtained. A pre-trained image generation model can be obtained. A set of parameters can then be adjusted based on the plurality of input images and synthetic image data generated with the pre-trained image generation model. The set of parameters and the pre-trained image generation model can then be utilized to generate a plurality of model-generated images. The set of parameters can be different from a plurality of pre-tuned parameters of the pre-trained image generation model. Adjusting the set of parameters can be based on a loss function that compares an output model-generated image against one or more input images. The adjustment of the parameters can be based on training output images that are generated based on a prompt being processed with the pre-trained image generation model and the set of parameters. The plurality of input images can depict the object from different perspectives. Additionally and/or alternatively, the plurality of input images can depict the object in different environments.

Additionally and/or alternatively, the plurality of input images descriptive of one or more particular objects can be processed with a pre-trained text-to-image generative model to generate a specialized text-to-image model and a unique identifier for the one or more particular objects. A prompt can be received and processed with the specialized text-to-image model to generate one or more model-generated images. The model-generated images can include the one or more particular objects based on the prompt including the unique identifier. The prompt can include text descriptive of a request for a particular type of environment be rendered, and the environment of the one or more model-generated images can be of the particular type of environment. The prompt may include further text conditioning (e.g., additional objects to include and/or a point of view for viewing the object). The unique identifier can include a set of characters and/or one or more embedding values. The one or more model-generated images may include the particular object depicted in a different perspective from the one or more particular perspectives of the plurality of input images. The particular objects can include clothes, furniture, food, drinks, vehicles, and/or other objects. The system may be merchant facing and/or consumer facing. Alternatively and/or additionally, the model-generated images may be automatically generated.

Large text-to-image models can enable high-quality and diverse synthesis of images from a given text prompt. However, the models can lack the ability to mimic the appearance of subjects in a given reference set and synthesize novel renditions of them in different contexts. The systems and methods disclosed herein can provide for “personalization” of text-to-image diffusion models (e.g., specializing the model to a user request). When provided with a few images of a subject (e.g., a subject in the images, which may include an object depicted in the image set), the system can fine-tune a pretrained text-to-image model (e.g., a diffusion model based image generation model) such that the pretrained text-to-image model learns to bind a unique identifier with that specific subject (e.g., a model-readable token generated to be associated with rendering the particular subject (e.g., particular topic)). Once the subject (e.g., the object) is embedded in the output domain of the model, the unique identifier can then be used to synthesize fully-novel photorealistic images of the subject contextualized in different scenes (e.g., the object can be rendered into different settings that may include different locations with different background features). By leveraging the semantic prior embedded in the model with an autogenous class-specific prior preservation loss, the system can synthesize the subject (e.g., an object) in diverse scenes, poses, views, and/or lighting conditions that do not appear in the reference images. The systems and methods can be leveraged for subject recontextualization, text-guided view synthesis, appearance modification (e.g., property modification, which may include changing the color, texture, shape, and/or other appearance features of the subject), and artistic rendering (e.g., rendering the subject in the artistic style of a particular genre or era all while preserving the subject's key features).

Large text-to-image models can perform well on large scale and large variety image generation based on sequence-to-sequence predictions; however, particular object instance rendering can experience difficulty (e.g., the models can struggle with realistic renderings of fine-grained details associated with particular products, such as features that differentiate that particular object from other objects in that object class). The systems and methods disclosed herein can fine-tune a pre-trained text-to-image model on a set of input images of an object to (1) fine-tune the model for photorealistic renderings of that particular object and (2) embed within the model an association between object rendering of that particular object and a particular unique identifier. The association can be leveraged such that when the image generation model (e.g., the text-to-image model) processes the unique identifier the set of fine-tuned parameters are utilized to perform the object rendering.

During the fine-tuning the set of parameters may be tuned as the remaining parameters of the image generation model are fixed (or frozen) in order to not reduce the generative capabilities of the image generation model with regards to other feature renderings. Moreover, in some implementations, the unique identifier can include a control token (e.g., a model-readable token) that can condition the image generation model to perform object rendering based on the embedded semantic prior (e.g., the semantic prior embedded during fine-tuning). The use of the unique identifier can provide for higher quality renderings of the particular object, while still being able to leverage the environment rendering capabilities of the pre-trained text-to-image model.

In some implementations, the set of parameters may be trained to learn a three-dimensional representation of the particular object (e.g., via neural radiance field tuning). The set of parameters of the image generation model can be tuned to process a three-dimensional position and a two-dimensional view direction relative to a requested object rendering position to generate a plurality of color predictions and a plurality of opacity predictions associated with rendering the object. The image generation model may then leverage the plurality of color predictions and the plurality of opacity predictions to render the object within one or more environments.

The systems and methods of the present disclosure provide a number of technical effects and benefits. As one example, the systems and methods can provide an image generation system for showcasing an object with different environments and/or objects without the cost and time that is required for traditional photography shoots. The objects can be accurately and realistically rendered in scenes that may not be readily accessible to an individual attempting to generate the object showcase. The image generation can be utilized for product displays, vision boards, art, etc.

Another technical benefit of the systems and methods of the present disclosure is the ability to leverage one or more pre-trained generative models to generate imagery including backgrounds, object ensembles, and showcases that can inspire lifestyle aspirations and aesthetics. The use of pre-trained generative models can reduce the computational resource cost of training new models, which can save time and resources.

Another example of technical effect and benefit relates to improved computational efficiency and improvements in the functioning of a computing system. For example, the systems and methods disclosed herein can leverage fixed parameter tuning to limit the parameters adjusted for object-specific parameter tuning. In particular, the systems and methods disclosed herein can add new parameters and/or only adjust a set number of parameters of the pre-trained generative model when parameter tuning for accurate object rendering. The parameter tuning can include adjusting one or more parameters of the generative model to accurately and realistically render the particular object. The parameter tuning may be limited to a set of parameters to avoid affecting the quality of other renderings and to reduce the computational cost of retraining the entire model.

Another example technical effect and benefit relates to improved computational efficiency and improvements in the functioning of a computing system. For example, a technical benefit of the systems and methods of the present disclosure is the ability to reduce the computational resources needed for training and/or tuning a generative model for generating high quality outputs for particular object generation. In particular, the generative model (e.g., an image generation model) can be utilized to generate model-generated images with a plurality of predicted pixels. In some implementations, the generative model and/or one or more soft prompts (e.g., a set of machine-learned parameters that can be processed with the input by the generative model) can be trained and/or tuned for particular object generation (e.g., image pixel prediction for a particular object).

In some implementations, the image generation system can be configured to receive, and/or obtain, one or more images descriptive of one or more objects in one or more environments and, as a result of receipt of the one or more input images, generate, determine, and/or provide one or more model-generated images that depict the one or more objects in one or more rendered environments that may differ from the one or more input environments. Thus, in some implementations, the example image generation system can include an image generation model (e.g., a generative image model) that is operable to generate synthetic images that depict the object in different environments, which may include different locations and/or different ensembles.

In particular, the image generation system can obtain one or more input images (e.g., three to five images) associated with one or more objects (e.g., the images may depict a particular object from one or more angles). The one or more input images may be from different times, depict different locations, and/or may have different resolutions and/or qualities. In some implementations, the one or more objects can include a clothing item, a toy, an electronic device, an individual, a furniture item, a vehicle, a building, and/or another item.

The one or more input images can be processed with an image generation model to generate one or more model-generated images. Processing the one or more input images can include conditioning the image generation model with the one or more input images to generate the one or more objects (e.g., adjusting one or more parameters of the image generation model based on the one or more input images). The image generation model can include a transformer model. In some implementations, the image generation model can include a diffusion model and/or a token-based transformer model. The image generation model 16 may be a pre-trained generative model.

The one or more model-generated images can include synthetic images that include predicted pixel data. The one or more model-generated images can depict the one or more objects in one or more environments. The one or more objects can be depicted in different lighting, in different environments, from different angles, and/or different poses than depicted in the one or more input images. In some implementations, the input data may include an input video. Additionally and/or alternatively, the output data can include one or more model-generated videos.

In some implementations, the present disclosure can be directed to an object-specific image generation system. In particular, the object-specific image generation system can obtain one or more input images (e.g., three to five images) associated with one or more objects (e.g., the images may depict a particular object from one or more angles). The one or more input images may be from different times, depict different locations, and/or may have different resolutions and/or qualities. In some implementations, the one or more objects can include a clothing item, a toy, an electronic device, an individual, a furniture item, a vehicle, a building, and/or another item.

The one or more input images can be utilized for parameter tuning. In particular, one or more parameters can be tuned (e.g., adjusted) based on the one or more input images. The parameter tuning can be performed to train the image generation model for object specific rendering (e.g., to increase the accuracy and/or realism for rendering the one or more objects).

The tuned image generation model can then be utilized to generate one or more model-generated images depicting the one or more objects in one or more environments. The tuned image generation model may include additional parameters and/or adjusted parameters from an obtained pre-trained image generation model.

A prompt can then be obtained. The prompt can include text data, image data, latent encoding data, statistical data, audio data, multimodal data, and/or other data. The prompt may be descriptive of a request to render the object with a particular environment, which may include a particular location, a particular lighting, and/or particular additional objects. In some implementations, the prompt may include a unique identifier that instructs the image generation model to render the one or more objects.

The prompt can be processed with the image generation model to generate one or more model-generated images. The image generation model can include a transformer model. In some implementations, the image generation model can include a diffusion model and/or a token-based transformer model. The image generation model may be a pre-trained generative model.

The one or more model-generated images can include synthetic images that include predicted pixel data. The one or more model-generated images can depict the one or more objects in one or more environments. The one or more objects can be depicted in different lighting, in different environments, from different angles, and/or different poses than depicted in the one or more input images. In some implementations, the one or more model-generated images can include one or more features generated based on the prompt. For example, a particular additional object and/or a particular scene may be rendered based on the prompt. The input data may include an input video. Additionally and/or alternatively, the output data can include one or more model-generated videos.

The present disclosure can be directed to a foreground-background image generation system. In particular, the image generation system can include obtaining a prompt and processing the prompt to generate one or more model-generated images.

For example, the image generation system can obtain a prompt from a user. The prompt can include text data, image data, audio data, latent encoding data, and/or multimodal data. The prompt may include a text string descriptive of a requested image rendering of a particular object in one or more environments. In some implementations, the prompt may include a request for multiple objects (e.g., a particular vase, a particular table, and a particular chair rendered within a living room) to be rendered in one or more environments.

The prompt can then be parsed via one or more parse blocks, which may include one or more classifiers and/or one or more natural language processing models. The prompt can be processed with the one or more parse blocks to identify and/or separate one or more terms and/or one or more identifiers associated with the particular object. In particular, the one or more parse blocks can be leveraged to determine the particular portion of the prompt that is descriptive of the particular object. The particular portion of the prompt may then be replaced with a unique object identifier to generate a tokenized prompt. The unique object identifier may include a control token associated with the particular object. The control token can be configured, trained, and/or tuned to condition the generative model for object-specific image rendering. Alternatively and/or additionally, the unique identifier may be utilized to perform a call (e.g., an application programming interface call) and/or retrieval to obtain an object-specific neural radiance field model and/or an object-specific soft prompt. The object-specific neural radiance field model and/or the object-specific soft prompt may have been trained and/or tuned on a set of images of the particular object. The training may be performed separately and/or with the generative model.

The image generation system can then leverage the object-specific neural radiance field model for object view synthesis rendering, while the generative model performs the pixel prediction for the remainder of the image rendering. For example, the generative model may process the tokenized prompt and an object rendering generated with the object-specific neural radiance field model in order to generate one or more model-generated images that include a realistic rendering of the object, while also including predicted pixels descriptive of features requested via the remaining portions of the prompt.

Alternatively and/or additionally, the tokenized prompt and the object-specific soft prompt may be processed with the generative model to generate the one or more model-generated images. For example, the object-specific soft prompt may include a set of model-readable weights (and/or parameters) that can condition the generative model for photo-realistic renderings of the particular object.

In some implementations, the generative model may be tuned for object-specific image rendering. The generative model may be tuned based on real world images of the object and/or may be tuned on view synthesis renderings generated with the object-specific neural radiance field model. The fine-tuned model may then be stored. The stored model can then be retrieved whenever the object identifier is detected.

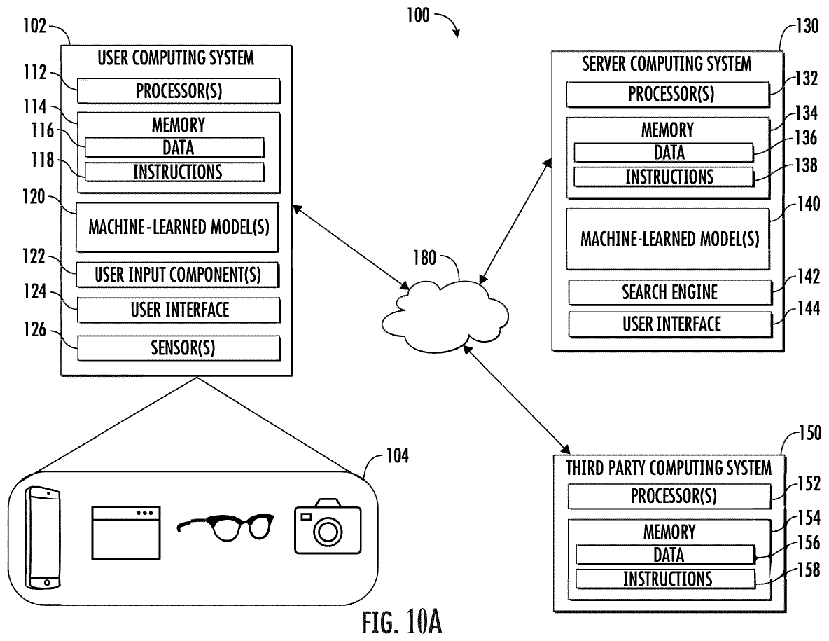

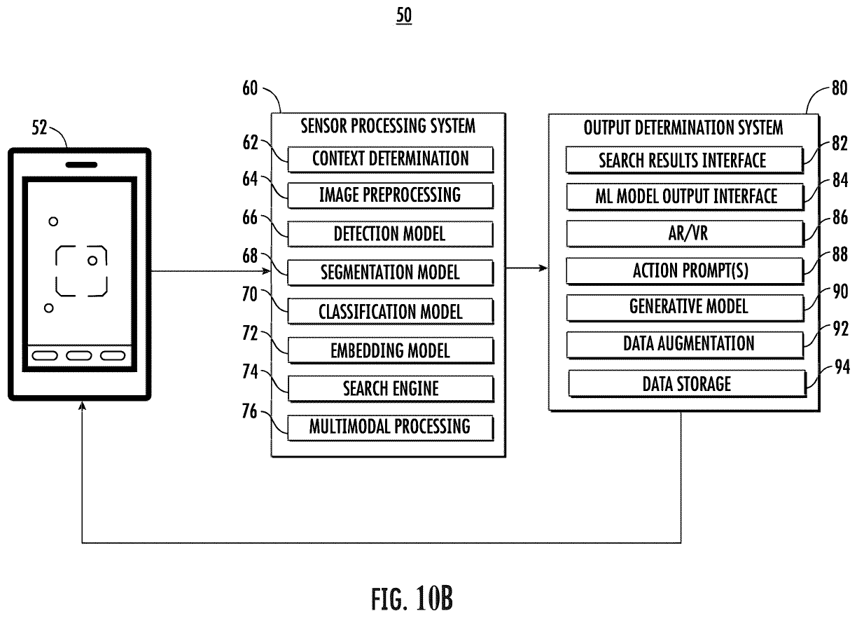

FIG. 10A depicts a block diagram of an example computing system 100 that performs style-aligned object image generation according to example embodiments of the present disclosure. The system 100 includes a user computing system 102, a server computing system 130, and/or a third party computing system 150 that are communicatively coupled over a network 180.

The user computing system 102 can include any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing system 102 to perform operations.

In some implementations, the user computing system 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 120 can be received from the server computing system 130 over network 180, stored in the user computing device memory 114, and then used or otherwise implemented by the one or more processors 112. In some implementations, the user computing system 102 can implement multiple parallel instances of a single machine-learned model 120 (e.g., to perform parallel machine-learned model processing across multiple instances of input data and/or detected features).

More particularly, the one or more machine-learned models 120 may include one or more detection models, one or more classification models, one or more segmentation models, one or more augmentation models, one or more generative models, one or more natural language processing models, one or more optical character recognition models, and/or one or more other machine-learned models. The one or more machine-learned models 120 can include one or more transformer models. The one or more machine-learned models 120 may include one or more neural radiance field models, one or more diffusion models, and/or one or more autoregressive language models.

The one or more machine-learned models 120 may be utilized to detect one or more object features. The detected object features may be classified and/or embedded. The classification and/or the embedding may then be utilized to perform a search to determine one or more search results. Alternatively and/or additionally, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models 120 can process image data, text data, audio data, and/or latent encoding data to generate output data that can include image data, text data, audio data, and/or latent encoding data. The one or more machine-learned models 120 may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask based segmentation).

Machine-learned model(s) can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) can include a single or multiple instances of the same model configured to operate on data from input(s). Machine-learned model(s) can include an ensemble of different models that can cooperatively interact to process data from input(s). For example, machine-learned model(s) can employ a mixture-of-experts structure. See, e.g., Zhou et al., Mixture-of-Experts with Expert Choice Routing, ARXIV: 2202.09368v2 (Oct. 14, 2022).

Input(s) can generally include or otherwise represent various types of data. Input(s) can include one type or many different types of data. Output(s) can be data of the same type(s) or of different types of data as compared to input(s). Output(s) can include one type or many different types of data.

Example data types for input(s) or output(s) include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs or outputs, example combinations of data types include image data and audio data, image data and natural language data, natural language data and software code data, image data and biometric data, sensor data and medical data, etc. It is to be understood that any combination of data types in an input or an output can be present.

An example input can include one or multiple data types, such as the example data types noted above. An example output can include one or multiple data types, such as the example data types noted above. The data type(s) of input can be the same as or different from the data type(s) of output. It is to be understood that the example data types noted above are provided for illustrative purposes only. Data types contemplated within the scope of the present disclosure are not limited to those examples noted above.

Additionally or alternatively, one or more machine-learned models 140 can be included in or otherwise stored and implemented by the server computing system 130 that communicates with the user computing system 102 according to a client-server relationship. For example, the machine-learned models 140 can be implemented by the server computing system 130 as a portion of a web service (e.g., a viewfinder service, a visual search service, an image processing service, an ambient computing service, and/or an overlay application service). Thus, one or more models 120 can be stored and implemented at the user computing system 102 and/or one or more models 140 can be stored and implemented at the server computing system 130.

The user computing system 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the user computing system 102 can store and/or provide one or more user interfaces 124, which may be associated with one or more applications. The one or more user interfaces 124 can be configured to receive inputs and/or provide data for display (e.g., image data, text data, audio data, one or more user interface elements, an augmented-reality experience, a virtual reality experience, and/or other data for display. The user interfaces 124 may be associated with one or more other computing systems (e.g., server computing system 130 and/or third party computing system 150). The user interfaces 124 can include a viewfinder interface, a search interface, a generative model interface, a social media interface, and/or a media content gallery interface.

The user computing system 102 may include and/or receive data from one or more sensors 126. The one or more sensors 126 may be housed in a housing component that houses the one or more processors 112, the memory 114, and/or one or more hardware components, which may store, and/or cause to perform, one or more software packets. The one or more sensors 126 can include one or more image sensors (e.g., a camera), one or more lidar sensors, one or more audio sensors (e.g., a microphone), one or more inertial sensors (e.g., inertial measurement unit), one or more biological sensors (e.g., a heart rate sensor, a pulse sensor, a retinal sensor, and/or a fingerprint sensor), one or more infrared sensors, one or more location sensors (e.g., GPS), one or more touch sensors (e.g., a conductive touch sensor and/or a mechanical touch sensor), and/or one or more other sensors. The one or more sensors can be utilized to obtain data associated with a user's environment (e.g., an image of a user's environment, a recording of the environment, and/or the location of the user).

The user computing system 102 may include, and/or be part of, a user computing device 104. The user computing device 104 may include a mobile computing device (e.g., a smartphone or tablet), a desktop computer, a laptop computer, a smart wearable, and/or a smart appliance. Additionally and/or alternatively, the user computing system may obtain from, and/or generate data with, the one or more user computing devices 104. For example, a camera of a smartphone may be utilized to capture image data descriptive of the environment, and/or an overlay application of the user computing device 104 can be utilized to track and/or process the data being provided to the user. Similarly, one or more sensors associated with a smart wearable may be utilized to obtain data about a user and/or about a user's environment (e.g., image data can be obtained with a camera housed in a user's smart glasses). Additionally and/or alternatively, the data may be obtained and uploaded from other user devices that may be specialized for data obtainment or generation.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIG. 10B.

Additionally and/or alternatively, the server computing system 130 can include and/or be communicatively connected with a search engine 142 that may be utilized to crawl one or more databases (and/or resources). The search engine 142 can process data from the user computing system 102, the server computing system 130, and/or the third party computing system 150 to determine one or more search results associated with the input data. The search engine 142 may perform term based search, label based search, Boolean based searches, image search, embedding based search (e.g., nearest neighbor search), multimodal search, and/or one or more other search techniques.

The server computing system 130 may store and/or provide one or more user interfaces 144 for obtaining input data and/or providing output data to one or more users. The one or more user interfaces 144 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

The user computing system 102 and/or the server computing system 130 can train the models 120 and/or 140 via interaction with the third party computing system 150 that is communicatively coupled over the network 180. The third party computing system 150 can be separate from the server computing system 130 or can be a portion of the server computing system 130. Alternatively and/or additionally, the third party computing system 150 may be associated with one or more web resources, one or more web platforms, one or more other users, and/or one or more contexts.

An example machine-learned model can include a generative model (e.g., a large language model, a foundation model, a vision language model, an image generation model, a text-to-image model, an audio generation model, and/or other generative models).

Training and/or tuning the machine-learned model can include obtaining a training instance. A set of training data can include a plurality of training instances divided between multiple datasets (e.g., a training dataset, a validation dataset, or testing dataset). A training instance can be labeled or unlabeled. The runtime inferences can form training instances when a model is trained using an evaluation of the model's performance on that runtime instance (e.g., online training/learning). Example data types for the training instance and various tasks associated therewith are described throughout the present disclosure.

Training and/or tuning can include processing, using one or more machine-learned models, the training instance to generate an output. The output can be directly obtained from the one or more machine-learned models or can be a downstream result of a chain of processing operations that includes an output of the one or more machine-learned models.

Training and/or tuning can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi- or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

Training and/or tuning can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Training and/or tuning can include implementing a number of generalization techniques (e.g., weight decays, dropouts, etc.) to improve the generalization capability of the models being trained.

In some implementations, the above training loop can be implemented for training a machine-learned model from an initialized state to a fully trained state (e.g., when the model exhibits a desired performance profile, such as based on accuracy, precision, recall, etc.).

In some implementations, the above training loop can be implemented for particular stages of a training procedure. For instance, in some implementations, the above training loop can be implemented for pre-training a machine-learned model. Pre-training can include, for instance, large-scale training over potentially noisy data to achieve a broad base of performance levels across a variety of tasks/data types. In some implementations, the above training loop can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

In some implementations, the computing system 100 may utilize one or more soft prompts for conditioning the one or more machine-learned models (120 and/or 140) for downstream tasks. The one or more soft prompts can include a set of tunable parameters that can be trained (or tuned) as the parameters of the one or more machine-learned models (120 and/or 140) are fixed. The one or more soft prompts 124 can be trained for a specific task and/or a specific set of tasks. Alternatively and/or additionally, the one or more soft prompts 124 may be trained to condition the one or more machine-learned models (120 and/or 140) to perform inferences for a particular individual, one or more entities, and/or one or more tasks such that the output is tailored for that particular individual, particular entities, and/or particular task. The one or more soft prompts 124 can be obtained and processed with one or more inputs by the one or more machine-learned models (120 and/or 140).

The one or more soft prompts can include a set of machine-learned weights. In particular, the one or more soft prompts can include weights that were trained to condition a generative model to generate model-generated content with one or more particular attributes. For example, the one or more soft prompts can be utilized by a user to generate content based on the fine-tuning. The one or more soft prompts can be extended to a plurality of tasks. For example, the computing system 100 may tune the set of parameters on a plurality of different content attributes and/or types. The one or more soft prompts may include a plurality of learned vector representations that may be model-readable.

A particular soft prompt can be obtained based on a particular task, individual, content type, etc. The particular soft prompt can include a set of learned parameters. The set of learned parameters can be processed with the generative model to generate the model-generated image.

The user computing system 102 and/or the server computing system 130 may store one or more soft prompts associated with the particular user and/or particular task. The soft prompt(s) can include a set of parameters. The user computing system 102 and/or the server computing system 130 may leverage the set of parameters of the soft prompt(s) and a generative model to generate a model-generated content item. In some implementations, the model-generated content item can be generated based on the set of parameters associated with the particular individual and/or task.

The utilization of a soft prompt (i.e., a set of parameters that can be processed with a generative model for downstream task conditioning) can reduce the computational cost for parameter tuning for object-specific content generation by reducing the parameters to be tuned. The set of parameters can be limited and may be adjusted while the parameters of the pre-trained generative model stay fixed. The set of parameters of the soft prompt can be utilized to condition the pre-trained generative model (e.g., the machine-learned image generation model and/or language model) for particular downstream tasks (e.g., response generation and/or image rendering).

In some implementations, the generative language model and/or one or more soft prompts (e.g., a set of machine-learned parameters that can be processed with the input by the generative language model) can be trained to generate content with particular attributes.

In some implementations, the server computing system 130 can include a prompt library. The prompt library can store a plurality of prompt templates (e.g., a plurality of hard prompt templates (e.g., text prompt templates)) and/or a plurality of soft prompts. The plurality of prompt templates can include hard prompt templates (e.g., text string data) that may be combined with the user input to generate a more detailed and complete prompt for the generative model to process. The templates can include text descriptive of the request. The templates may be object-specific, user-specific, and/or content-specific. The plurality of prompt templates may include few-shot examples.

The prompt library can store a plurality of soft prompts. The plurality of soft prompts may be associated with a plurality of different content attributes and/or a plurality of different individuals. The plurality of soft prompts can include learned parameters and/or learned weights that can be processed with the generative model to condition the generative model to generate content items with particular attributes. The plurality of soft prompts may have been tuned by freezing the parameters of a pre-trained generative model, while the parameters of the soft prompt are learned based on a particular task and/or user. The plurality of soft prompts can include a plurality of different soft prompts associated with a plurality of different users and/or a plurality of different sets of users.

The third party computing system 150 can include one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the third party computing system 150 to perform operations. In some implementations, the third party computing system 150 includes or is otherwise implemented by one or more server computing devices.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, the task can be a generative task, and the one or more machine-learned models (e.g., 120 and/or 140) can be configured to output content generated in view of one or more inputs. For instance, the inputs can be or otherwise represent data of one or more modalities that encodes context for generating additional content.

In some implementations, the task can be a text completion task. The machine-learned models can be configured to process the inputs that represent textual data and to generate the outputs that represent additional textual data that completes a textual sequence that includes the inputs. For instance, the machine-learned models can be configured to generate the outputs to complete a sentence, paragraph, or portion of text that follows from a portion of text represented by inputs.

In some implementations, the task can be an instruction following task. The machine-learned models can be configured to process the inputs that represent instructions to perform a function and to generate the outputs that advance a goal of satisfying the instruction function (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the instructions (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the instructions (e.g., natural language responses, programming language responses, machine language responses, etc.). One or more outputs can be iteratively or recursively generated to sequentially process and accomplish steps toward accomplishing the requested functionality. For instance, an initial output can be executed by an external system or be processed by the machine-learned models to complete an initial step of performing a function. Multiple steps can be performed, with a final output being obtained that is responsive to the initial instructions.

In some implementations, the task can be a question answering task. The machine-learned models can be configured to process the inputs that represent a question to answer and to generate the outputs that advance a goal of returning an answer to the question (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the question (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the question (e.g., natural language responses, programming language responses, machine language responses, etc.). One or more outputs can be iteratively or recursively generated to sequentially process and accomplish steps toward answering the question. For instance, an initial output can be executed by an external system or be processed by the machine-learned models to complete an initial step of obtaining an answer to the question (e.g., querying a database, performing a computation, executing a script, etc.). Multiple steps can be performed, with a final output being obtained that is responsive to the question.

In some implementations, the task can be an image generation task. The machine-learned models can be configured to process the inputs that represent context regarding a desired portion of image content. The context can include text data, image data, audio data, etc. Machine-learned models can be configured to generate the outputs that represent image data that depicts imagery related to the context. For instance, the machine-learned models can be configured to generate pixel data of an image. Values for channels associated with the pixels in the pixel data can be selected based on the context (e.g., based on a probability determined based on the context).

In some implementations, the task can be an audio generation task. Machine-learned models can be configured to process the inputs that represent context regarding a desired portion of audio content. The context can include text data, image data, audio data, etc. The machine-learned models can be configured to generate the outputs that represent audio data related to the context. For instance, the machine-learned models can be configured to generate waveform data in the form of an image (e.g., a spectrogram). Values for channels associated with pixels of the image can be selected based on the context. The machine-learned models can be configured to generate waveform data in the form of a sequence of discrete samples of a continuous waveform. Values of the sequence can be selected based on the context (e.g., based on a probability determined based on the context).

In some implementations, the task can be a data generation task. Machine-learned models can be configured to process the inputs that represent context regarding a desired portion of data (e.g., data from various data domains, such as sensor data, image data, multimodal data, statistical data, etc.). The desired data can be, for instance, synthetic data for training other machine-learned models. The context can include arbitrary data types. The machine-learned models can be configured to generate the outputs that represent data that aligns with the desired data. For instance, the machine-learned models can be configured to generate data values for populating a dataset. Values for the data objects can be selected based on the context (e.g., based on a probability determined based on the context).

The user computing system may include a number of applications (e.g., applications 1 through N). Each application may include its own respective machine learning library and machine-learned model(s). For example, each application can include a machine-learned model. Example applications include a text messaging application, an email application, a dictation application, a virtual keyboard application, a browser application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

The user computing system 102 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing system 100.

The central intelligence layer can communicate with a central device data layer. The central device data layer can be a centralized repository of data for the computing system 100. The central device data layer may communicate with a number of other components of the computing device, such as, for example, one or more sensors, a context manager, a device state component, and/or additional components. In some implementations, the central device data layer can communicate with each device component using an API (e.g., a private API).

FIG. 10B depicts a block diagram of an example computing system 50 that performs style-aligned object image generation according to example embodiments of the present disclosure. In particular, the example computing system 50 can include one or more computing devices 52 that can be utilized to obtain, and/or generate, one or more datasets that can be processed by a sensor processing system 60 and/or an output determination system 80 to feedback to a user that can provide information on features in the one or more obtained datasets. The one or more datasets can include image data, text data, audio data, multimodal data, latent encoding data, etc. The one or more datasets may be obtained via one or more sensors associated with the one or more computing devices 52 (e.g., one or more sensors in the computing device 52). Additionally and/or alternatively, the one or more datasets can be stored data and/or retrieved data (e.g., data retrieved from a web resource). For example, images, text, and/or other content items may be interacted with by a user. The interacted with content items can then be utilized to generate one or more determinations.

The one or more computing devices 52 can obtain, and/or generate, one or more datasets based on image capture, sensor tracking, data storage retrieval, content download (e.g., downloading an image or other content item via the internet from a web resource), and/or via one or more other techniques. The one or more datasets can be processed with a sensor processing system 60. The sensor processing system 60 may perform one or more processing techniques using one or more machine-learned models, one or more search engines, and/or one or more other processing techniques. The one or more processing techniques can be performed in any combination and/or individually. The one or more processing techniques can be performed in series and/or in parallel. In particular, the one or more datasets can be processed with a context determination block 62, which may determine a context associated with one or more content items. The context determination block 62 may identify and/or process metadata, user profile data (e.g., preferences, user search history, user browsing history, user purchase history, and/or user input data), previous interaction data, global trend data, location data, time data, and/or other data to determine a particular context associated with the user. The context can be associated with an event, a determined trend, a particular action, a particular type of data, a particular environment, and/or another context associated with the user and/or the retrieved or obtained data.

The sensor processing system 60 may include an image preprocessing block 64. The image preprocessing block 64 may be utilized to adjust one or more values of an obtained and/or received image to prepare the image to be processed by one or more machine-learned models and/or one or more search engines 74. The image preprocessing block 64 may resize the image, adjust saturation values, adjust resolution, strip and/or add metadata, and/or perform one or more other operations.

In some implementations, the sensor processing system 60 can include one or more machine-learned models, which may include a detection model 66, a segmentation model 68, a classification model 70, an embedding model 72, and/or one or more other machine-learned models. For example, the sensor processing system 60 may include one or more detection models 66 that can be utilized to detect particular features in the processed dataset. In particular, one or more images can be processed with the one or more detection models 66 to generate one or more bounding boxes associated with detected features in the one or more images.

Additionally and/or alternatively, one or more segmentation models 68 can be utilized to segment one or more portions of the dataset from the one or more datasets. For example, the one or more segmentation models 68 may utilize one or more segmentation masks (e.g., one or more segmentation masks manually generated and/or generated based on the one or more bounding boxes) to segment a portion of an image, a portion of an audio file, and/or a portion of text. The segmentation may include isolating one or more detected objects and/or removing one or more detected objects from an image.

The one or more classification models 70 can be utilized to process image data, text data, audio data, latent encoding data, multimodal data, and/or other data to generate one or more classifications. The one or more classification models 70 can include one or more image classification models, one or more object classification models, one or more text classification models, one or more audio classification models, and/or one or more other classification models. The one or more classification models 70 can process data to determine one or more classifications.

In some implementations, data may be processed with one or more embedding models 72 to generate one or more embeddings. For example, one or more images can be processed with the one or more embedding models 72 to generate one or more image embeddings in an embedding space. The one or more image embeddings may be associated with one or more image features of the one or more images. In some implementations, the one or more embedding models 72 may be configured to process multimodal data to generate multimodal embeddings. The one or more embeddings can be utilized for classification, search, and/or learning embedding space distributions.

The sensor processing system 60 may include one or more search engines 74 that can be utilized to perform one or more searches. The one or more search engines 74 may crawl one or more databases (e.g., one or more local databases, one or more global databases, one or more private databases, one or more public databases, one or more specialized databases, and/or one or more general databases) to determine one or more search results. The one or more search engines 74 may perform feature matching, text based search, embedding based search (e.g., k-nearest neighbor search), metadata based search, multimodal search, web resource search, image search, text search, and/or application search.

Additionally and/or alternatively, the sensor processing system 60 may include one or more multimodal processing blocks 76, which can be utilized to aid in the processing of multimodal data. The one or more multimodal processing blocks 76 may include generating a multimodal query and/or a multimodal embedding to be processed by one or more machine-learned models and/or one or more search engines 74.

The output(s) of the sensor processing system 60 can then be processed with an output determination system 80 to determine one or more outputs to provide to a user. The output determination system 80 may include heuristic based determinations, machine-learned model based determinations, user selection based determinations, and/or context based determinations.

The output determination system 80 may determine how and/or where to provide the one or more search results in a search results interface 82. Additionally and/or alternatively, the output determination system 80 may determine how and/or where to provide the one or more machine-learned model outputs in a machine-learned model output interface 84. In some implementations, the one or more search results and/or the one or more machine-learned model outputs may be provided for display via one or more user interface elements. The one or more user interface elements may be overlayed over displayed data. For example, one or more detection indicators may be overlaid over detected objects in a viewfinder. The one or more user interface elements may be selectable to perform one or more additional searches and/or one or more additional machine-learned model processes. In some implementations, the user interface elements may be provided as specialized user interface elements for specific applications and/or may be provided uniformly across different applications. The one or more user interface elements can include pop-up displays, interface overlays, interface tiles and/or chips, carousel interfaces, audio feedback, animations, interactive widgets, and/or other user interface elements.

Additionally and/or alternatively, data associated with the output(s) of the sensor processing system 60 may be utilized to generate and/or provide an augmented-reality experience and/or a virtual-reality experience 86. For example, the one or more obtained datasets may be processed to generate one or more augmented-reality rendering assets and/or one or more virtual-reality rendering assets, which can then be utilized to provide an augmented-reality experience and/or a virtual-reality experience 86 to a user. The augmented-reality experience may render information associated with an environment into the respective environment. Alternatively and/or additionally, objects related to the processed dataset(s) may be rendered into the user environment and/or a virtual environment. Rendering dataset generation may include training one or more neural radiance field models to learn a three-dimensional representation for one or more objects.

In some implementations, one or more action prompts 88 may be determined based on the output(s) of the sensor processing system 60. For example, a search prompt, a purchase prompt, a generate prompt, a reservation prompt, a call prompt, a redirect prompt, and/or one or more other prompts may be determined to be associated with the output(s) of the sensor processing system 60. The one or more action prompts 88 may then be provided to the user via one or more selectable user interface elements. In response to a selection of the one or more selectable user interface elements, a respective action of the respective action prompt may be performed (e.g., a search may be performed, a purchase application programming interface may be utilized, and/or another application may be opened).

In some implementations, the one or more datasets and/or the output(s) of the sensor processing system 60 may be processed with one or more generative models 90 to generate a model-generated content item that can then be provided to a user. The generation may be prompted based on a user selection and/or may be automatically performed (e.g., automatically performed based on one or more conditions, which may be associated with a threshold amount of search results not being identified).

The one or more generative models 90 can include language models (e.g., large language models and/or vision language models), image generation models (e.g., text-to-image generation models and/or image augmentation models), audio generation models, video generation models, graph generation models, and/or other data generation models (e.g., other content generation models). The one or more generative models 90 can include one or more transformer models, one or more convolutional neural networks, one or more recurrent neural networks, one or more feedforward neural networks, one or more generative adversarial networks, one or more self-attention models, one or more embedding models, one or more encoders, one or more decoders, and/or one or more other models. In some implementations, the one or more generative models 90 can include one or more autoregressive models (e.g., a machine-learned model trained to generate predictive values based on previous behavior data) and/or one or more diffusion models (e.g., a machine-learned model trained to generate predicted data based on generating and processing distribution data associated with the input data).

The one or more generative models 90 can be trained to process input data and generate model-generated content items, which may include a plurality of predicted words, pixels, signals, and/or other data. The model-generated content items may include novel content items that are not the same as any pre-existing work. The one or more generative models 90 can leverage learned representations, sequences, and/or probability distributions to generate the content items, which may include phrases, storylines, settings, objects, characters, beats, lyrics, and/or other aspects that are not included in pre-existing content items.

The one or more generative models 90 may include a vision language model.

The vision language model can be trained, tuned, and/or configured to process image data and/or text data to generate a natural language output. The vision language model may leverage a pre-trained large language model (e.g., a large autoregressive language model) with one or more encoders (e.g., one or more image encoders and/or one or more text encoders) to provide detailed natural language outputs that emulate natural language composed by a human.

The vision language model may be utilized for zero-shot image classification, few shot image classification, image captioning, multimodal query distillation, multimodal question and answering, and/or may be tuned and/or trained for a plurality of different tasks. The vision language model can perform visual question answering, image caption generation, feature detection (e.g., content monitoring (e.g., for inappropriate content)), object detection, scene recognition, and/or other tasks.

The vision language model may leverage a pre-trained language model that may then be tuned for multimodality. Training and/or tuning of the vision language model can include image-text matching, masked-language modeling, multimodal fusing with cross attention, contrastive learning, prefix language model training, and/or other training techniques. For example, the vision language model may be trained to process an image to generate predicted text that is similar to ground truth text data (e.g., a ground truth caption for the image). In some implementations, the vision language model may be trained to replace masked tokens of a natural language template with textual tokens descriptive of features depicted in an input image. Alternatively and/or additionally, the training, tuning, and/or model inference may include multi-layer concatenation of visual and textual embedding features. In some implementations, the vision language model may be trained and/or tuned via jointly learning image embedding and text embedding generation, which may include training and/or tuning a system to map embeddings to a joint feature embedding space that maps text features and image features into a shared embedding space. The joint training may include image-text pair parallel embedding and/or may include triplet training. In some implementations, the images may be utilized and/or processed as prefixes to the language model.

The one or more generative models 90 may be stored on-device and/or may be stored on a server computing system. In some implementations, the one or more generative models 90 can perform on-device processing to determine suggested searches, suggested actions, and/or suggested prompts. The one or more generative models 90 may include one or more compact vision language models that may include less parameters than a vision language model stored and operated by the server computing system. The compact vision language model may be trained via distillation training. In some implementations, the visional language model may process the display data to generate suggestions. The display data can include a single image descriptive of a screenshot and/or may include image data, metadata, and/or other data descriptive of a period of time preceding the current displayed content (e.g., the applications, images, videos, messages, and/or other content viewed within the past 30 seconds). The user computing device may generate and store a rolling buffer window (e.g., 30 seconds) of data descriptive of content displayed during the buffer. Once the time has elapsed, the data may be deleted. The rolling buffer window data may be utilized to determine a context, which can be leveraged for query, content, action, and/or prompt suggestion.

In some implementations, the generative models 90 can include machine-learned sequence processing models. An example system can pass inputs to sequence processing models. Sequence processing models can include one or more machine-learned components. Sequence processing models can process the data from inputs to obtain an input sequence. Input sequence can include one or more input elements obtained from inputs. The sequence processing model can process the input sequence using prediction layers to generate an output sequence. The output sequence can include one or more output elements generated based on input sequence. The system can generate outputs based on output sequence.

Sequence processing models can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, Google, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, arXiv:2010.11929v2 (Jun. 3, 2021), audio domains, see, e.g., Agostinelli et al., MusicLM: Generating Music From Text, arXiv:2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing models can process one or multiple types of data simultaneously. Sequence processing models can include relatively large models (e.g., more parameters, computationally expensive, etc.), relatively small models (e.g., fewer parameters, computationally lightweight, etc.), or both.

In general, sequence processing models can obtain an input sequence using data from inputs. For instance, input sequence can include a representation of data from inputs 2 in a format understood by sequence processing models. One or more machine-learned components of sequence processing models can ingest the data from inputs, parse the data into pieces compatible with the processing architectures of sequence processing models (e.g., via “tokenization”), and project the pieces into an input space associated with prediction layers (e.g., via “embedding”).

Sequence processing models can ingest the data from inputs and parse the data into a sequence of elements to obtain input sequence. For example, a portion of input data from inputs can be broken down into pieces that collectively represent the content of the portion of the input data. The pieces can provide the elements of the sequence.

In some implementations, processing the input data can include tokenization. For example, a tokenizer may process a given portion of an input source and output a series of tokens (e.g., corresponding to input elements) that represent the portion of the input source. Various approaches to tokenization can be used. For instance, textual input sources can be tokenized using a byte-pair encoding (BPE) technique. See, e.g., Kudo et al., SentencePiece: A simple and language independent subword tokenizer and detokenizer for Neural Text Processing, Proceedings of the 2018 Conference on Empirical Methods in Natural Language Processing (System Demonstrations), pages 66-71 (Oct. 31-Nov. 4, 2018), https://aclanthology.org/D18-2012.pdf. Image-based input sources can be tokenized by extracting and serializing patches from an image.

In general, arbitrary data types can be serialized and processed into an input sequence.

Prediction layers can predict one or more output elements based on the input elements. Prediction layers can include one or more machine-learned model architectures, such as one or more layers of learned parameters that manipulate and transform the inputs to extract higher-order meaning from, and relationships between, input elements. In this manner, for instance, example prediction layers can predict new output elements in view of the context provided by input sequence.

Prediction layers can evaluate associations between portions of input sequence and a particular output element. These associations can inform a prediction of the likelihood that a particular output follows the input context. For example, consider the textual snippet, “The carpenter's toolbox was small and heavy. It was full of ______.” Example prediction layers can identify that “It” refers back to “toolbox” by determining a relationship between the respective embeddings. Example prediction layers can also link “It” to the attributes of the toolbox, such as “small” and “heavy.” Based on these associations, prediction layers can, for instance, assign a higher probability to the word “nails” than to the word “sawdust.”

A transformer is an example architecture that can be used in prediction layers. See, e.g., Vaswani et al., Attention Is All You Need, arXiv: 1706.03762v7 (Aug. 2, 2023). A transformer is an example of a machine-learned model architecture that uses an attention mechanism to compute associations between items within a context window. The context window can include a sequence that contains input sequence and potentially one or more output elements. A transformer block can include one or more attention layers and one or more post-attention layers (e.g., feedforward layers, such as a multi-layer perceptron).

Prediction layers can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layers can leverage various kinds of artificial neural networks that can understand or generate sequences of information.

Output sequence can include or otherwise represent the same or different data types as input sequence. For instance, input sequence can represent textual data, and output sequence can represent textual data. The input sequence can represent image, audio, or audiovisual data, and output sequence can represent textual data (e.g., describing the image, audio, or audiovisual data). It is to be understood that prediction layers, and any other interstitial model components of sequence processing models, can be configured to receive a variety of data types in input sequences and output a variety of data types in output sequences.

The output sequence can have various relationships to an input sequence. Output sequence can be a continuation of input sequence. The output sequence can be complementary to the input sequence. The output sequence can translate, transform, augment, or otherwise modify input sequence. The output sequence can answer, evaluate, confirm, or otherwise respond to input sequence. The output sequence can implement (or describe instructions for implementing) an instruction provided via an input sequence.

The output sequence can be generated autoregressively. For instance, for some applications, an output of one or more prediction layers can be passed through one or more output layers (e.g., softmax layer) to obtain a probability distribution over an output vocabulary (e.g., a textual or symbolic vocabulary) conditioned on a set of input elements in a context window. In this manner, for instance, the output sequence can be autoregressively generated by sampling a likely next output element, adding that element to the context window, and re-generating the probability distribution based on the updated context window, and sampling a likely next output element, and so forth.

The output sequence can also be generated non-autoregressively. For instance, multiple output elements of the output sequence can be predicted together without explicit sequential conditioning on each other. See, e.g., Saharia et al., Non-Autoregressive Machine Translation with Latent Alignments, arXiv: 2004.07437v3 (Nov. 16, 2020).

The output sequence can include one or multiple portions or elements. In an example content generation configuration, the output sequence can include multiple elements corresponding to multiple portions of a generated output sequence (e.g., a textual sentence, values of a discretized waveform, computer code, etc.). In an example classification configuration, the output sequence can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

The output determination system 80 may process the one or more datasets and/or the output(s) of the sensor processing system 60 with a data augmentation block 92 to generate augmented data. For example, one or more images can be processed with the data augmentation block 92 to generate one or more augmented images. The data augmentation can include data correction, data cropping, the removal of one or more features, the addition of one or more features, a resolution adjustment, a lighting adjustment, a saturation adjustment, and/or other augmentation.

In some implementations, the one or more datasets and/or the output(s) of the sensor processing system 60 may be stored based on a data storage block 94 determination.

The output(s) of the output determination system 80 can then be provided to a user via one or more output components of the user computing device 52. For example, one or more user interface elements associated with the one or more outputs can be provided for display via a visual display of the user computing device 52.

The processes may be performed iteratively and/or continuously. One or more user inputs to the provided user interface elements may condition and/or affect successive processing loops.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system for style-aligned image generation, the system comprising:
one or more processors; and
one or more non-transitory computer-readable media that collectively store instructions that, when executed by the one or more processors, cause the computing system to perform operations, the operations comprising:
obtaining an object image, a style image, and a text description, wherein the object image depicts a particular object, wherein the style image comprises a particular style, and wherein the text description comprises a request for a scene comprising one or more particular features;
processing the object image, the style image, and the text description with an image generation model to generate a model-generated image, wherein the model-generated image depicts the particular object within a model-generated scene that comprises the one or more particular features, wherein the model-generated image comprises the particular style, wherein the image generation model generates the model-generated image by:
generating an object mask based on the object image, wherein the object mask descriptive of a silhouette of the particular object depicted in the object image;
generating an object embedding based on the object image and the object mask, wherein the object embedding is descriptive of a plurality of object features;
generating a model-generated scene based on the style image and the text description, wherein the model-generated scene comprises pixel data descriptive of the one or more particular features requested by the text description, and wherein the model-generated scene comprises the particular style of the style image; and
generating the model-generated image based on the model-generated scene and the object embedding, wherein the model-generated image comprises the particular object rendered into the model-generated scene; and
providing the model-generated image as output.

2. The system of claim 1, wherein the object mask and object embedding are generated with the image generation model.

3. The system of claim 1, wherein generating a model-generated scene based on the style image and the text description comprises performing an attention sharing bypass during the diffusion process.

4. The system of claim 1, wherein the particular style of the style image comprises at least one of a specific image saturation, a specific contrast, a specific lighting, a specific filter, or a specific visual effect.

5. The system of claim 1, wherein obtaining the style image comprises:
obtaining metadata associated with a user;
determining a web resource associated with the metadata; and
determining a particular content item from the web resource to obtain as the style image.

6. The system of claim 1, wherein the image generation model performs adaptive instance normalization during model-generated scene generation.

7. The system of claim 1, wherein the object embedding comprises a learned probability distribution associated with a plurality of color values and a plurality of opacity values.

8. The system of claim 1, wherein the model-generated scene is generated without fine-tuning the image generation model on a plurality of training images that comprise the particular style of the style image.

9. The system of claim 1, wherein the image generation model comprises a transformer model, and wherein the model-generated scene is generated based on allowing target features of the style image to bypass at least a portion of a self-attention block of the transformer model.

10. The system of claim 1, wherein the image generation model comprises a diffusion model trained to generate novel images based on processing a text string.

11. A computer-implemented method for style-aligned image generation, the method comprising:
obtaining, by a computing system comprising one or more processors, an object image, a style image, and a text description, wherein the object image depicts a particular object, wherein the style image comprises a particular style, and wherein the text description comprises a request for a background comprising one or more particular features;
processing, by the computing system, the object image to generate an object mask descriptive of a silhouette of the particular object depicted in the object image;
processing, by the computing system, the object image and the object mask to generate an object embedding, wherein the object embedding is descriptive of a plurality of object features;
processing, by the computing system, the style image and the text description with an image generation model to generate a model-generated background that comprises pixel data descriptive of the one or more particular features requested by the text description and comprising the particular style of the style image;
processing, by the computing system, the model-generated background and the object embedding with the image generation model to generate a model-generated image that comprises the particular object rendered into the model-generated background; and
providing, by the computing system, the model-generated image as output.

12. The method of claim 11, wherein the text description is based on an input search query input by a user.

13. The method of claim 12, wherein the object image is at least one of:
determined based on performing a search with at least a portion of the input search query; or
input with the input search query by the user.

14. The method of claim 12, wherein the style image is determined based on a context associated with the input search query being input.

15. The method of claim 11, wherein obtaining the style image comprises:
obtaining a plurality of example images associated with a user;
generating an image cluster based on determining at least a subset of the plurality of example images comprise a shared style; and
generating the style image based on the image cluster.

16. The method of claim 11, wherein the particular style of the style image comprises a specific composition of target features of the style image, wherein target features are assorted in a particular configuration.

17. One or more non-transitory computer-readable media that collectively store instructions that, when executed by one or more computing devices, cause the one or more computing devices to perform operations, the operations comprising:
obtaining an object image, a style image, and a text description, wherein the object image depicts a particular object, wherein the style image comprises a particular style, and wherein the text description comprises a request for a scene comprising one or more particular features;
processing the object image with an image generation model to generate an object embedding, wherein the object embedding is generated by:
generating an object mask descriptive of a silhouette of the particular object depicted in the object image;
generating the object embedding based on the object image and the object mask, wherein the object embedding is descriptive of a plurality of object features;
processing the style image and the text description with the image generation model to generate a model-generated scene that comprises pixel data descriptive of the one or more particular features requested by the text description and comprising the particular style of the style image;
processing the model-generated scene and the object embedding with the image generation model to generate a model-generated image that comprises the particular object rendered into the model-generated scene; and
providing the model-generated image for display.

18. The one or more non-transitory computer-readable media of claim 17, wherein the model-generated scene is generated without fine-tuning the image generation model on the particular style of the style image.

19. The one or more non-transitory computer-readable media of claim 17, wherein the model-generated scene differs from a first scene depicted in the object image, wherein the model-generated scene differs from a second scene depicted in the style image, and wherein the particular object differs from the plurality of objects depicted in the style image.

20. The one or more non-transitory computer-readable media of claim 17, wherein the image generation model comprises a generative text-to-image model that was pre-trained to generate a plurality of pixel predictions based on an input text string.
